(19) United States
(12) Patent Application Publication
(10) Pub. No.: US 2002/0140245 A1
(43) Pub. Date: Oct. 3, 2002

(54) Interlocking slidable assembly useful for a movable floor extension for motor vehicle cargo areas

(76) Inventors: James C. Coleman II, Cincinnati, OH (US); Franklin L. Mink, Lake Orion, MI (US)

Correspondence Address: Smith, Guttag, Hasse & Nesbitt Ltd., Suite 316, 7577 Central Park Blvd., Mason, OH, 45040, US

(21) Appl. No.: 10/127,133

(22) Filed: Apr. 22, 2002

Related U.S. Application Data
(62) Division of application No. 09/651,216, filed on Aug. 30, 2000.
Application No. 09/651,216 is a continuation-in-part of application No. 09/498,550, filed on Feb. 4, 2000, now abandoned.
Application No. 09/651,216 is a continuation-in-part of application No. 09/494,058, filed on Jan. 28, 2000, now Pat. No. 6,312,034.
(60) Provisional application No. 60/176,642, filed on Jan. 18, 2000.
(60) Provisional application No. 60/167,098, filed on Nov. 23, 1999.

(51) Int. Cl. B62D 33/02

(52) U.S. Cl. 296/26.09

(57) ABSTRACT

An interlocking slidable assembly useful for movable extensible platforms, such as a movable or sliding floor or plate extension used with the rear cargo areas of a motor vehicle. This assembly includes an elongated guide member such as a rail having a T-shaped segment and a follower member such as a generally C-shaped or U-shaped track. The track is configured to slidably interlock with the rail and has a surface slidably in contact with a surface of the rail so that the track can be moved to various positions along the rail. At least the surfaces of the track and rail that are in contact comprise materials, such as aluminum and ultra high molecular polyethylene, that provide, in combination, a relatively low coefficient of friction therebetween. The track and rail combination can further includes a locking mechanism for the purpose of locking or securing the track at various predetermined locations along the rail. The track can have channel that slidably receives the rail and is oriented to face downwardly to minimize the amount of dirt and other debris that is collected than can clog the channel and thus make it more difficult to slide the track along the rail.

### CROSS-REFERENCE TO RELATED APPLICATIONS

This application is a continuation-in-part of co-pending U.S. Nonprovisional Applications Serial No. 09/498,550 filed Feb. 4, 2000, and Ser. No. 09/494,058 filed Jan. 28, 2000, and also claims the benefit of co-pending U.S. Provisional Patent Application Serial No. 60/176,642, filed Jan. 18, 2000.

### TECHNICAL FIELD

The present application relates to a slidable assembly having slidably interlocking follower and guide members useful for movable extensible platforms and other movable structural members such as a movable or slidable floor or plate extension for rear cargo areas, such as truck beds and other cargo bed areas, of motor vehicles such as pick up trucks, sport utility vehicles (SUVs), station wagons and vans. The present application further relates to a slidable assembly where the follower member has a channel that slidably receives the guide member and that faces downwardly to minimize the collection of dirt and other debris.

### BACKGROUND OF THE INVENTION

With the proliferation of compact, mid-size and full-size pickup trucks with short beds, generally ranging from 4 to 6.5 feet in length, there is a limitation on the ability of truck owners to effectively haul longer items typically accommodated by longer beds (e.g., a 4 foot×8 foot sheet of plywood). Several approaches have been previously employed to expand the cargo carrying capacity of pickup truck beds. For example, U.S. Pat. No. 4,023,850 (Tillery), issued 1977); U.S. Pat. No. 4,531,773 to (Smith), issued 1985; and U.S. Pat. No. 5,755,480 (Bryan), issued 1998, each disclose tailgate extension devices to provide a longer bed floor area. While these prior tailgate extension devices do provide for an expanded cargo floor area, the steps necessary for their assembly and regular use are relatively complex. In addition, when not in use as a bed extension, these prior devices serve no alternative beneficial purpose.

Another approach is presented in U.S. Pat. No. 5,700,047 (Leitner, et al), issued 1997, which discloses a U-shaped “truck bed extender” that can be mounted to the walls of the rear portion of a pickup bed and rotated inside the bed to serve as a storage/retaining compartment for loaded items or outside the bed onto the lowered tailgate to effectively expand the enclosed cargo area. While retention is provided for cargo items that extend onto the lowered tailgate, this prior device does not truly expand or extend the truck bed or cargo area floor.

Another approach to the expansion of the cargo carrying capacity of a pickup truck bed previously employed involves the development of an expandable/retractable bed in which the walls and floor of the bed itself have the ability to extend to accommodate larger load items and retract to a shortened bed length. Examples of this approach are disclosed in U.S. Pat. No. 4,950,123 (Brockhaus), issued 1990 and U.S. Pat. No. 5,816,637 (Adams et al), issued 1998. While these prior devices provide for an expanded cargo area via extension of bed walls and floor, their construction and installation is necessarily complex, in that the expansion mechanism is a duplicative element in the manufacture of an entire truck bed.

Still another approach focusing more on increased ease of access to stored cargo items than for bed extension involves the development of plates that slidably engage the floor of the pickup bed cargo area floor via roller means. Several examples of this approach are presented in U.S. Pat. No. 4,993,088 (Chuck), issued Feb. 19, 1991; U.S. Pat. No. 5,456,511 (Webber), issued 1995; U.S. Pat. No. 5,513,941 (Kulas et al), issued 1996; U.S. Pat. No. 5,649,731 (Tognetti), issued 1997; and U.S. Pat. No. 5,938,262 (Mills), issued 1999. While these prior devices provide ease of access to loaded cargo items and potentially an expanded cargo area floor, their construction is unnecessarily complex, employing roller means as a method for mounting of the floor plate to the floor of the pickup bed. The roller means by which the load floor/plate engages the floor of the cargo area are susceptible to mechanical failure during the course of typical usage of a truck bed cargo area (i.e., rollers inhibited by dirt and debris or broken/damaged as a result of loading and hauling of heavy items). Also, examples of such devices currently available from aftermarket manufactures are relatively expensive (ranging from approximately $700 to $2,000) due in part to their complexity and manufacturing cost.

U.S. Pat. No. 5,098,146 (Albrecht et al), issued May 24, 1992, discloses a variation of these slidable plates where parallel spaced C-shaped channels 15 are attached to the floor bed and slidably receive inverted T-shaped blocks 26 that are mounted to sliding plate 20. This prior device still uses rollers 18 interposed between the C-shaped channels 15 to permit the sliding plate 20 to be easily moved. In addition, C-shaped channels 15 point upwardly, thus making them vulnerable to receiving dirt or debris that can potentially clog these channels and make it more difficult to move slidable plate 20.

Concerning the proliferation of multiple purpose vehicles such as SUVs, vans and station wagons, the rear cargo area of such vehicles is subjected to a diverse range of uses by consumers such as hauling groceries, luggage, landscaping materials, outdoor gear/sports equipment, etc. A problem faced by owners of such vehicles is how to protect the upholstery of the cargo area from damage associated with the loading and retrieval of cargo, as well as from dampness and dirt associated with certain load items. Another problem faced by owners of such vehicles is how to restrain and/or separate loaded cargo during travel. An additional problem is the discomfort and potential for back injury associated with the necessity of leaning into the cargo area for loading and unloading heavy cargo items.

The issue of protection of the upholstery of a multiple purpose vehicle cargo area has been addressed previously through the development of cargo area liners of various types. Some examples of these cargo liners are disclosed in U.S. Pat. No. 4,979,772 (Carey et al), issued 1990; U.S. Pat. No. 5,110,171 (Anthony), issued 1992; and U.S. Pat. No. 5,322,335 (Niemi), issued 1994. These prior liners serve well for protection of the interior of the cargo area. However, they do not address the other previously identified problems of restraining/separating cargo during travel, as well as minimizing the potential for discomfort or injury in loading/unloading heavy cargo.

The further evolution of multiple purpose vehicle cargo area liners has involved the adaptation of various types of divider mechanisms to mount to the liner to address the need to separate and/or restrain cargo items during travel. Examples of this improvement are disclosed in U.S. Pat. No. 5,269,447 (Gower et al), issued 1993; U.S. Pat. No. 5,562,321 (VanHoose), issued 1996; and U.S. Pat. No. 5,976,672 (Hodgetts), issued 1999. These prior divider mechanisms address the need for both interior protection and cargo retention. However, they do not offer a solution to the problem of potential injury from leaning into the cargo area for access to loading/unloading heavy cargo items.

An approach to addressing all three problems stated previously can be seen in U.S. Pat. No. 5,634,408 (Jarkowski), issued 1997, which discloses a vehicle cargo tray which lines the floor of the cargo area and can extend outward via roller means so as to slide beyond the open cargo area for loading. Interior protection and cargo retention devices are also included. However, the construction of this prior tray involving complex moving parts, such as roller means, presents the opportunity for mechanical malfunction, reduced reliability, and/or reduced durability during the typical use of a multiple purpose vehicle cargo area (e.g., roller means inhibited by dirt/debris or damaged from loading/carrying heavy items), as well as significantly increased cost to potential consumers.

Another approach to cargo area protection involves the recent development of pickup truck beds comprised partially or totally of composite/plastic materials. The use of composite/plastic materials for construction of a cargo area for a pickup truck, and potentially multiple purpose vehicles (i.e., vans, SUVs, station wagons, etc.) in the future, obviates the need for a protective liner, since the material from which the cargo area is constructed is inherently resistant to damage. While such composite/plastic materials solve the problem of protecting the cargo area from damage associated with loading, unloading and hauling cargo, the issues of increased ease of access to loading/unloading cargo (to eliminate the potential for injury associated with leaning into the cargo area to load or unload a heavy cargo item), extension/expansion of the load floor (to accommodate oversized cargo items), and provision of a means for restraining/dividing cargo still need to be addressed.

### SUMMARY OF THE INVENTION

The present invention relates to an interlocking slidable assembly useful for movable extensible platforms or other movable structural members used with a base member, such as a movable or sliding floor or plate extension used with the rear cargo areas of a motor vehicle. This assembly comprises:

a. an elongated guide member associated with one of the structural member and the base member;

b. a follower member associated with the other of the structural member and the base member that is configured to slidably interlock with the guide member and has a surface slidably in contact with a surface of the guide member so as to be movable along the guide member from a first position to a second position;

c. wherein the surfaces of the follower member and guide member comprise materials, that provide, in combination, a relatively low coefficient of friction therebetween.

The present invention further relates to a movable structure for use with a base member, which comprises:

a. a movable structural member;

b. an elongated guide member associated with the base member;

c. a follower member associated with the structural member and having a channel that is configured to slidably receive and interlock with the guide member so as to be movable along the guide member from a first position to a second position;

d. wherein the channel is oriented to face downwardly towards the base member.

The present invention provides a number of advantages over prior devices. These advantages include:

(a) providing a slidable assembly for use with a variety movable extensible platforms or other movable structural members such as an integrated sliding floor extension for a truck bed and multiple purpose vehicle cargo area to (1) increase the utility of shorter beds for hauling longer items and (2) increase the ease of and access to loading and unloading of items stored in the bed or cargo area, rather than leaning into the bed compartment from the side or rear or into the vehicle cargo area to load or retrieve a cargo item;

(b) providing a slidable assembly that has a relatively simple structure, for example, an interlocking rail and track combination, is relatively easy to operate (e.g., has no or few moving parts such as rollers and is relatively resistant to mechanical malfunction during typical use) and also allows the extensible platform member, such as a slidable floor extension plate, to engage the floor and/or side walls of the bed/cargo area;

(c) providing a slidable assembly that can be used with a sliding floor extension that allows the truck bed and multiple purpose vehicle cargo area to have components such as molded or drilled holes that will allow the truck bed or cargo area to be divided into compartments or to mount, attach or otherwise include cargo dividers or other restraining devices, toolboxes or other such items in the cargo bed area;

(d) providing a slidable assembly where the guide and follower members, such as an interlocking rail and track combination, can be attached, or have the capability to be attached (such as via pre-drilled or pre-molded penetrating holes in the rail and/or track) to one or the other of the structural and base members, or can be molded/formed/stamped or otherwise integral with one or more of the structural or base members;

(e) providing a slidable assembly where the follower and guide members use combinations of materials having a relatively low coefficient of friction on the surfaces that are in slidable contact so that additional elements such as rollers are unnecessary for the follower member to slide freely along the guide member, especially when the follower member is associated with a platform or other movable structural member that is relatively heavy or can carry or support a relatively heavy load; and

(f) providing a slidable assembly with a follower member that is associated with the platform member that has a channel to slidably receive the guide member that is oriented to face downwardly towards the base member to minimize the collection of dirt and other debris that can potentially clog the follower member and thus interfere with the ability of the follower member to freely slide along the guide member.

The present invention can uniquely provide a simplified slidable assembly such as a rail and track combination(s) to integrate the motor vehicle (e.g., pickup truck or multiple purpose vehicle) cargo area with a sliding floor or extension plate that engages the floor and/or side walls of the cargo area to increase the ease of access to cargo, extend the pickup bed load floor (e.g., approximately 70 percent of truck bed length), and provide a multifunctional platform for mounting, attaching or otherwise incorporating cargo dividers/restraining devices, toolboxes, coolers, canoe racks or other such items. This can be achieved whether the cargo area is constructed of metal, composite/plastic or a combination of the two. In particular, the slidable assembly of the present invention is particularly useful for providing for the bed or cargo area of a motor vehicle (e.g., pickup trucks, vans, SUVs, other passenger vehicles, etc.) a sliding floor extension to enable the stored or hauled items therein to be easily removed from the rear of the truck or passenger vehicle, as well as to increase the length of the bed/cargo area floor.

An optional but preferred feature of the present invention is to provide a mechanism for securing the platform or other movable structural member in a secure stored position, as well as a locked extended position. In this preferred embodiment, the platform or other movable structural member, such as the load floor extension plate of a motor vehicle cargo area, would be secured or locked in position by a mechanism, such as two spring-loaded locking pins that protrude outwardly from the inside of the follower member, such as a molded track, that are located at the end of the extension plate nearest to the front of the bed/cargo area. The locking pins would protrude outwardly to fill, for example, horizontally drilled or molded holes in the guide member, such as a rail that receives the aforementioned track, at spaced intervals. This would allow the extension plate to be extended and locked/secured at various lengths. When used with a pickup truck bed, where the floor extension plate extends past the end of the lowered truck tailgate, the extension plate would preferably rest on a support structure, such as two pads integrally molded with or attached to the upper side of the tailgate, for added support. The spring-loaded pins could then be retracted and released through the operation of a release and retraction mechanism, such as a one-hand-operated handle located at the end of the extension plate nearest to the truck tailgate or cargo area hatch/door. This preferred locking mechanism would allow for the sliding floor extension plate to be easily removed from the bed/cargo area for routine cleaning purposes or replacement if damaged.

### BRIEF DESCRIPTION OF THE DRAWINGS

FIG. 1A is a view from the rear of the bed of a representative pickup truck (without tailgate) showing an embodiment of the slidable assembly of the present invention in the form of a rail and track combination for a sliding floor extension plate.

FIG. 1B is a view from the rear of the cargo area of a representative sport utility vehicle (without the cargo hatch in place) showing an embodiment of a slidable assembly of the present invention in the form of a rail and track combination for a sliding extension floor plate.

FIG. 2A is an enlarged, sectional view of the rail and track combination of FIGS. 1A and 1B;

FIG. 2B is an enlarged sectional view of an alternative embodiment of the rail and track combination of FIG. 2A.

FIG. 3A is a top plan view of the truck bed of FIG. 1A with the tailgate down showing the sliding floor extension plate in a stored position.

FIG. 3B is a top plan view of the cargo area of a representative sport utility vehicle (SUV) showing the sliding floor extension in a stored position.

FIG. 4A is a top plan view of the truck bed of FIG. 3A showing the sliding floor extension plate in an extended position.

FIG. 4B is a top plan view of the SUV cargo area of FIG. 3B showing the sliding floor extension plate in an extended position.

FIG. 5A is a sectional view taken along line 5A-5A of FIG. 4A;

FIG. 5B is a sectional view taken along line 5B-5B of FIG. 4B.

FIG. 6 is view of the underside of the sliding floor extension plate of FIG. 4A showing the locking mechanism used to lock and secure the sliding floor extension plate in place at spaced intervals.

FIG. 7 is an enlarged view of the spring-loaded locking pins of FIG. 6.

FIG. 8 is sectional view of an alternative embodiment of the rail and track combination of FIG. 2A that also shows the locking mechanism of FIG. 7 in a locked position.

FIG. 9 is an enlarged view of the handle release portion of FIGS. 4A and 4B of the locking/unlocking mechanism.

FIG. 10 is sectional view of an alternative embodiment of the slidable assembly of FIGS. 1A, 1B and 2A.

FIG. 10A is an enlarged sectional view of a portion of the slidable assembly of FIG 10.

FIG. 11 is a sectional view of an alternative embodiment of the rail of FIG. 10.

FIG. 12 is sectional view of an alternative embodiment of the slidable assembly of FIGS. 1A, 1B and 2A.

FIG. 12A is enlarged sectional view of a portion of the slidable assembly of FIG. 12.

FIG. 13 is a sectional view of an alternative embodiment of the rails of FIG. 12.

FIG. 14 is an enlarged sectional view of a portion of an alternative embodiment of the slidable assembly of FIG. 12.

FIG. 15 is a sectional view of another alternative embodiment of the rail of FIG. 14.

FIG. 16 is a sectional view of an alternative embodiment of the slidable assembly of FIG. 12.

FIG. 16A is enlarged sectional view of a portion of the slidable assembly of FIG. 16.

FIG. 17 is sectional view an alternative embodiment of the slidable assembly of FIGS. 12, 13 and 16.

FIG. 17A is an enlarged sectional view of a portion of the slidable assembly of FIG. 17

FIG. 18 is a sectional view of an alternative embodiment of the rails of FIG. 16.

FIG. 19 is an enlarged sectional view of a portion of another alternative embodiment of the slidable assembly of FIGS. 10 and 12.

FIG. 20 is a sectional view of another alternative embodiment of the slidably assembly of FIGS. 12 and 19.

FIG. 20A is an enlarged sectional view of a portion of the slidable assembly of FIG. 20.

FIG. 21 is a sectional view of an alternative embodiment of the tracks of FIG. 20.

FIG. 22 is a sectional view of an alternative embodiment of the slidable assembly of FIG. 10.

FIG. 22A is an enlarged sectional view of a portion of the slidable assembly of FIG. 22.

FIG. 23 is a sectional view of an alternative embodiment of the slidable assembly of FIG. 22.

FIG. 23A is an enlarged sectional view of a portion of the slidable assembly of FIG 23.

FIG. 24 is a sectional view of another alternative embodiment of the slidable assembly of the present invention.

FIG. 25 is an enlarged sectional view of a portion of the slidable assembly of FIG. 24.

FIG. 26 is sectional view of an alternative embodiment of the slidable assembly of FIG. 24.

FIG. 26A is an enlarged sectional view of a portion of the slidable assembly of FIG. 24.

FIG. 27 is sectional view of another alternative embodiment of the slidable assembly of FIG. 24.

FIG. 28 is an enlarged sectional view of a portion of the slidable assembly of FIG. 27.

FIG. 29 is sectional view of an alternative embodiment of the slidable assembly of FIG. 27.

FIG. 30 is an enlarged sectional view of a portion of the slidable assembly of FIG. 29.

FIG. 31 is sectional view of an alternative embodiment of the slidable assembly of FIG. 29.

FIG. 32 is sectional view of an alternative embodiment of the slidable assembly of FIG. 31.

### DETAILED DESCRIPTION OF THE INVENTION

The present invention can best be understood by reference to the drawings that illustrate various embodiments of the slidable assembly within the scope of the present invention. For illustrative purposes, the embodiments of this slidable assembly are shown as being used with a movable, extensible platform member in the form of a slidable floor extension plate for a pickup truck bed or the cargo area of a sport utility vehicle (SUV). However, the slidable assembly of the present invention can be used with a variety of other movable or slidable extensible platforms or other movable support or structural members such as utility trailer floors, loading ramps, all terrain vehicle (ATV) beds, recreational vehicle (RV) storage bins, stereo component racks, marine storage bins and electronic racks, roof carriers, aircraft storage bins, tool box slides, fishing tackle boxes or drawers, food service tray racks, library book shelves, and casket slides, or other any storage bin, rack, box, or shelf that needs slidable access, for a variety of mobile and/or stationary structures, or vehicles. In certain embodiments of the present invention, the movable structural member and the follower member can be an integral structure such as a movable shelf that has respective spaced edges that comprise the follower member.

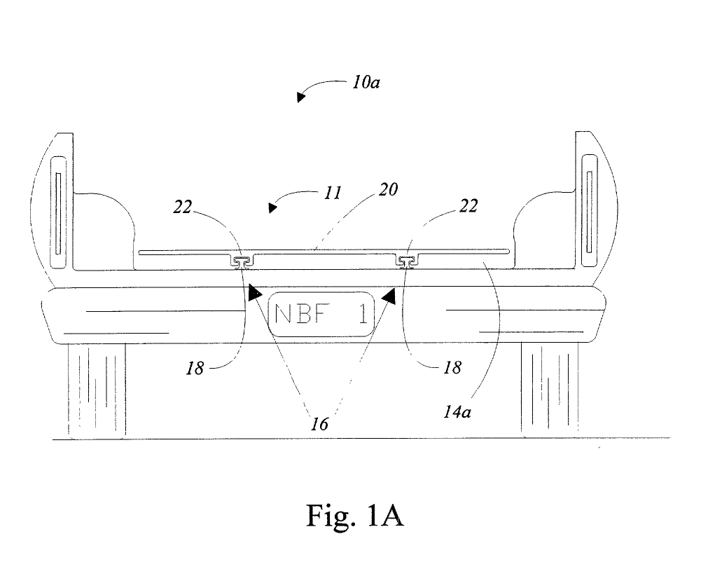

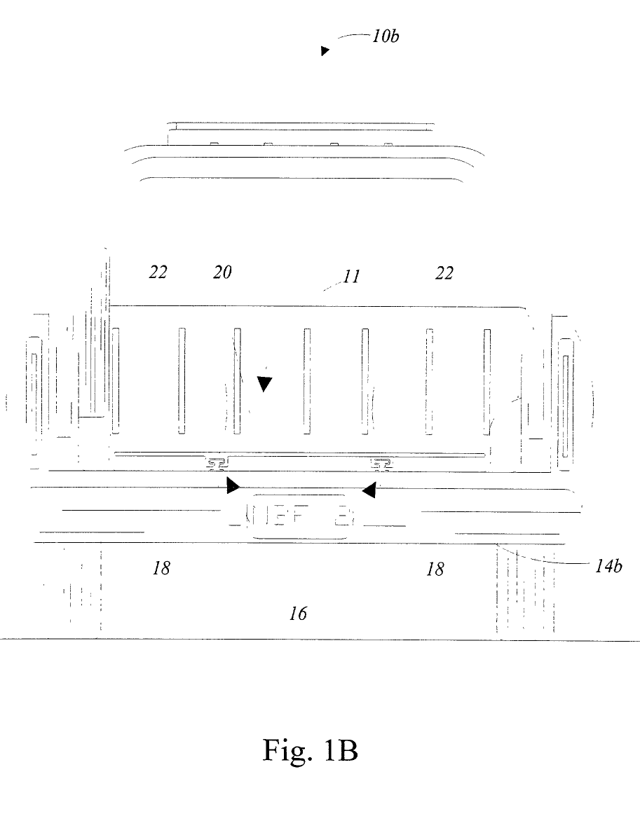

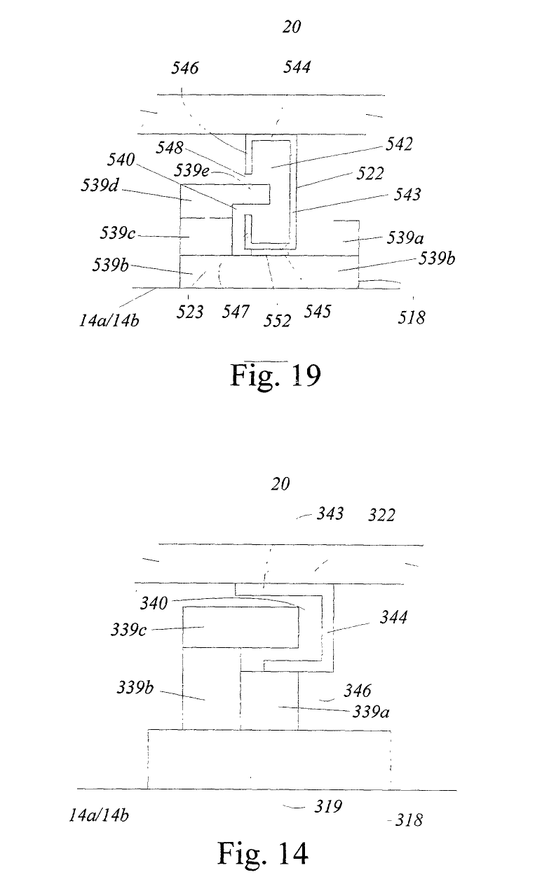

As shown in the drawings, the slidable assembly of the present invention can be used with a motor vehicle such as pickup truck 10a shown in FIG. 1A, or a sport utility vehicle (SUV) 10b shown in FIG. 1B, to provide a sliding load floor extension structure indicated generally as 11 for a motor vehicle cargo area indicated as 14a for a pickup truck bed (see FIG. 1A) and 14b for an SUV cargo area (see FIG. 1B). The slidable assembly of the present invention used in structure 11 is shown in FIGS. 1A and 1B in the form of a pair spaced apart assemblies or combinations 16, each comprising an elongated rail 18 as the guide member that is received by an elongated track 22 as the follower member that is configured to slidably interlock with the rail. As also shown in FIGS. 1A and 1B, assemblies 16 are used to movably support sliding bed floor extension plate indicated as 20 that can be made of a lightweight molded composite/plastic material, metal plating (encased or not within a shell of composite materials) or other suitable material. While FIGS. 1A and 1B show a pair of such rail 18 and track 22 combinations for the slidable assembly 16, assembly 16 can also be in the form of one such track and rail combination, or can be in the form of a plurality of such rail and track combinations where two, three or more such combinations are used with floor extension plate 20.

The rail 18 and track 22 can be made from one or more metal and/or composite/plastic materials and can be formed or associated to be integral with one of the bed/cargo area 14a/14b or the floor extension plate 20, such as by molding, stamping or other suitable manner of integration, or can be formed separately from such materials, and then mounted, connected, or otherwise attached to the bed/cargo area or floor extension plate mechanically by bolts, screws or other suitable fasteners, adhesively by glue or Velcro, any combination of mechanical or adhesive attachment, or any other suitable manner of attachment. For example, floor extension plate 20 can be formed to have on the underside or sides thereof (depending on whether rails 18 are mounted on the floor or on the side walls of bed/cargo area 14a/14b) to have one or more tracks 22 integrally formed or attached to the extension plate 20 so that it can be slidably mounted on rails 18. Also, rails 18 can be integral with or attached to the side walls or floor of bed/cargo area 14a/14b (the tracks then being integral with or attached to the underside or sides of floor extension plate 20) or can be integral with the floor extension plate 20 (the tracks then being integral with or attached to bed/cargo area 14a/14b). For certain embodiments of slidable assemblies 16 to be described hereafter, it can be preferred to have the rails 18 integral with or attached to the floor of bed/cargo area 14a/14b, with the tracks 22 being integral with or attached to the underside of floor extension plate 20. Also, as shown in the FIGS. 1A and 1B, assemblies 16 comprising the rail 18 and track 22 combinations are typically identical in construction or configuration, although they need not be so.

Referring again specifically to the drawings, FIG. 1A shows a representative truck bed 14a, made, for example, of metal and/or composite/plastic materials, with an identical pair of rails 18 that are integral with or attached to the floor of the truck bed 14a and are slidably received in an interlocking relationship by corresponding tracks 22 that are integral with or attached to the underside of sliding truck bed floor extension plate 20 made, for example, of composite materials or metal plating (encased or not in composite materials). FIG. 1B shows a representative sport utility vehicle with a cargo area 14b having a similar pair of rails 18 that are integral with or attached to the floor of cargo area 14b and slidably receive corresponding tracks 22 that are integral with or attached to the underside of the sliding floor extension plate 20.

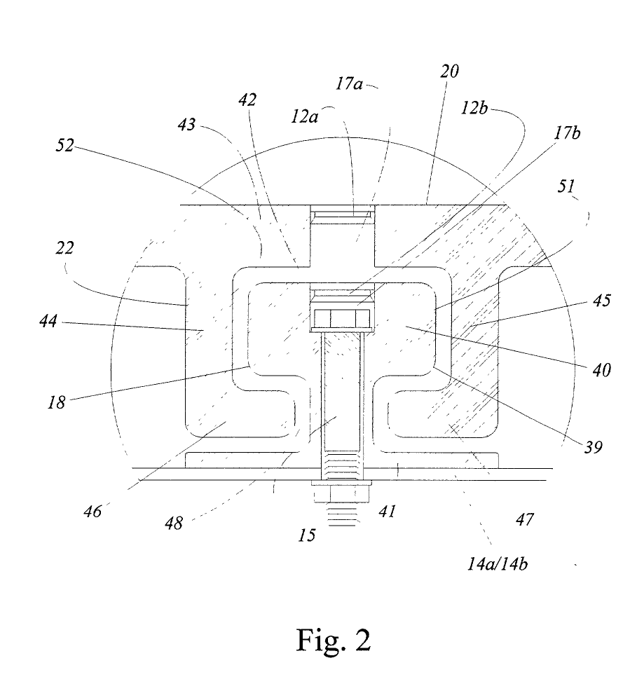

As shown in FIG. 2A, the configuration of rail 18 and track 22 are such that they form an interlocking fit or combination so that track 22 will not fall off of rail 18 as track 22 moves or slides along rail 18 as sliding floor extension plate 20 is moved from one position to another position. (FIG. 2B shows an alternative embodiment of the assembly 16 of FIG. 2A in which the rail 18 is attached to the floor of the truck bed/SUV cargo area 14a/14b by a bolt 15 or other suitable fastener countersunk to allow for insertion of caps or plugs 12a and 12b into countersinks 17a and 17b in track 22 and rail 18, respectively, to prevent dirt and debris from collecting in the holes.) As particularly shown in FIG. 2A, rail 18 has a generally T-shaped segment 39 having a head portion 40 and neck portion 41 that slidably fits within or is received by channel 42 of generally C-shaped (or U-shaped) track 22. Track 22 has a base segment 43 and a pair of spaced apart generally L-shaped segments 44 and 45 that extend generally outwardly from base segment 43 and define channel 42. L-shaped segments 44 and 45 have respective inwardly extending ends 46 and 47 that define an opening indicated by 48 of channel 42 and enclose the neck portion 41 of segment 39 of rail 18. As also shown in FIG. 2A, channel 42 is oriented to face downwardly towards the floor of the bed/cargo area. This minimizes the amount of dirt and other debris that could enter, for example, through opening 48 and collect in channel 42. As a result, channel 42 is less likely to become clogged with such dirt and debris that could interfere with the ability of track 22 to freely slide along the surface 51 of segment 39 of rail 18.

So that T-shaped segment 39 of rail 18 can easily and slidably move within channel 42 of track 22, the surface 51 of segment 39 and the surface 52 of track 22 adjacent channel 42 that are in contact with each other should comprise materials that provide, in combination, a relatively low coefficient of friction therebetween, and preferably impart additional properties such as relatively high resistance and corrosion resistance. As used herein, the term “a relatively low coefficient of friction” usually refers to a coefficient of friction (both static and dynamic when lubricated) of about 0.1 or less. Surfaces 51 and 52 can be provided with a combined relatively low coefficient of friction by coating, spraying, dipping adhering, or otherwise applying materials having such a combined relatively low coefficient of friction to such surfaces only, by making segment 39 of rail 18 and/or the segment of track 22 adjacent channel 42 from such materials, or by simply making rail 18 and/or track 22 entirely from such materials. Suitable combinations of materials that provide a relatively low coefficient of friction therebetween are combinations of a metal such as aluminum, stainless steel, bronze, brass, copper, cadmium, chromium, tungsten carbide, zinc, magnesium, and alloys thereof on one of the surfaces, with a relatively low coefficient of friction polymer such as ultra high molecular weight polyethylene (e.g., TIVAR brand name ultra high molecular weight polyethylene such as TIVAR 1000 manufactured by Poly Hi Solidur) or polytetrafluoroethylene (e.g., Teflon) on the other surface, combinations of a plastic such as nylon, on one of the surfaces, with a relatively low coefficient of friction polymer on the other surface, or a combinations of a relatively low coefficient of friction polymer on both surfaces. Particularly preferred combinations involve using ultra high molecular weight polyethylene for making all or at least the contact surface 51 of rail 18, and nylon or more preferably aluminum in making all or at least the contact surface 52 of track 22, or optionally a strip of a higher strength and more abrasion resistant metal such as stainless steel as the contact surface 52 of track 22 with the remainder of the track being made of nylon or more preferably aluminum.

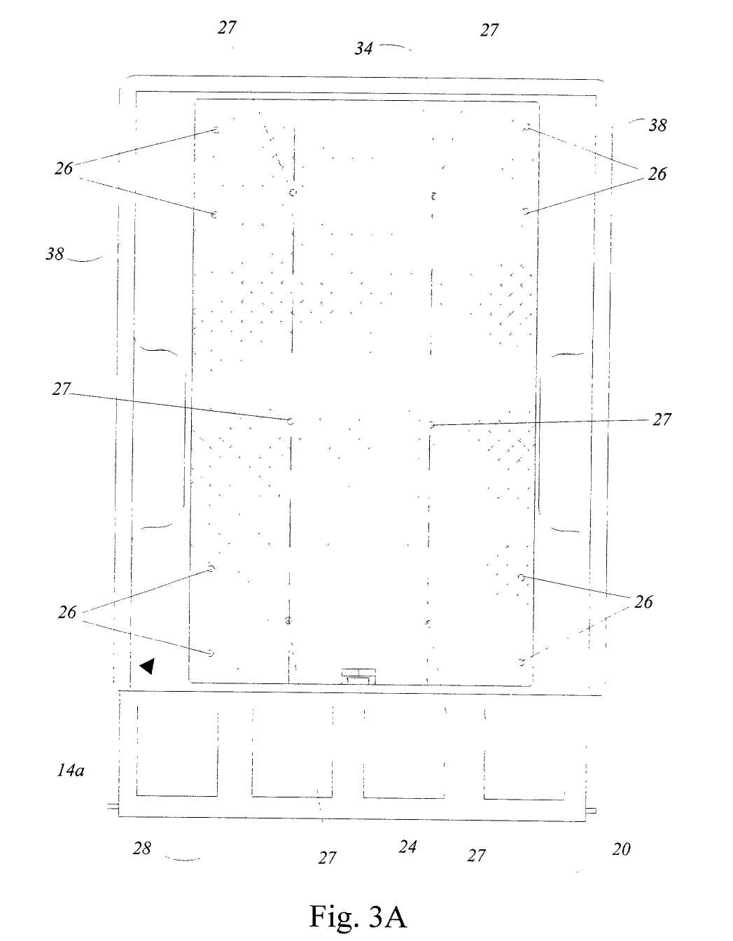

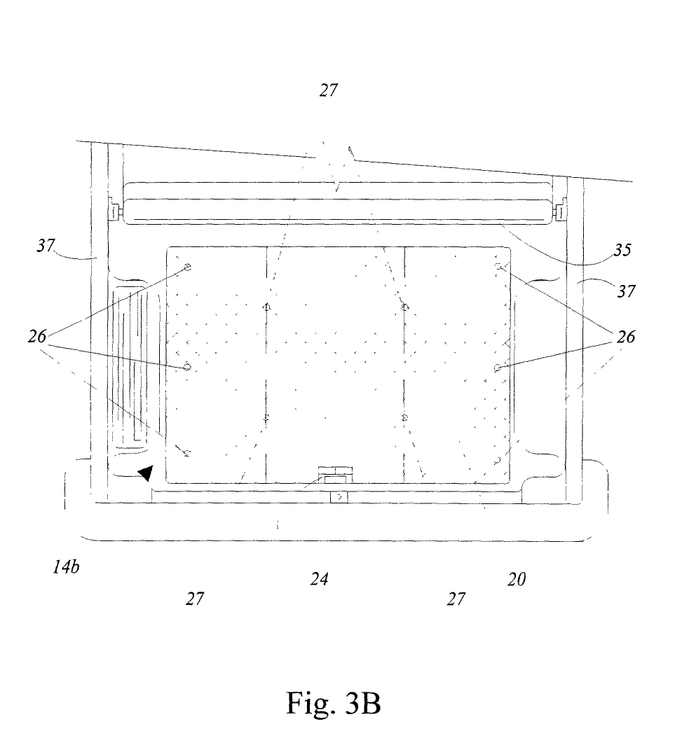

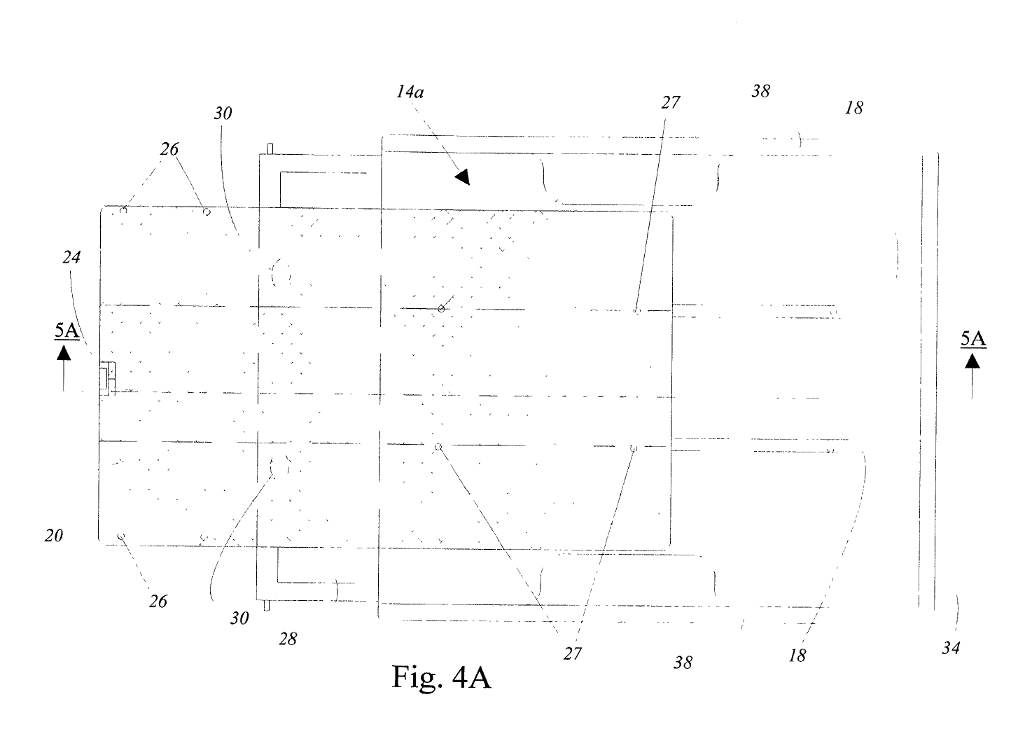

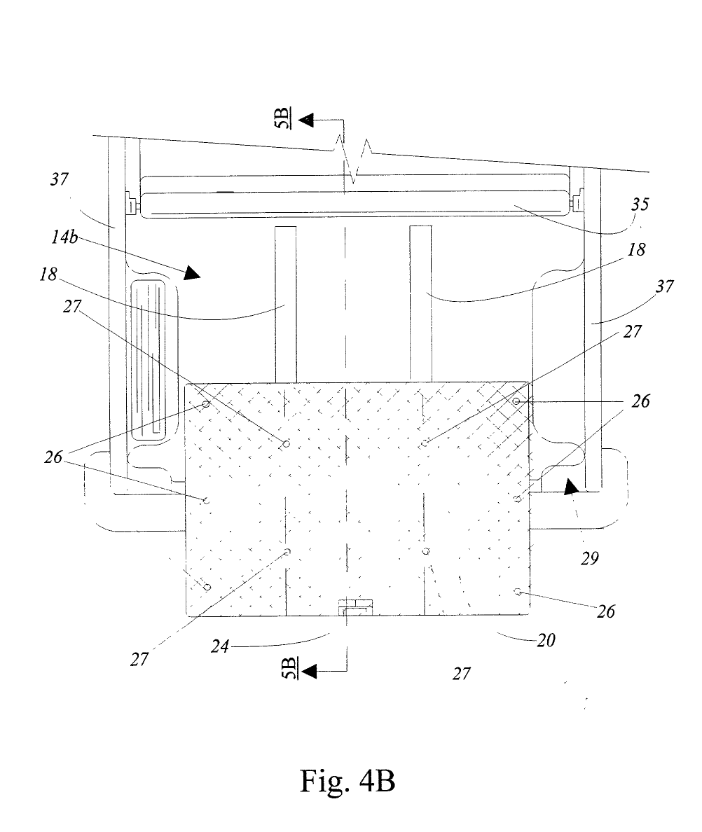

Sliding floor extension plate 20 can be extendable between a fully forward and locked position (as shown in FIGS. 3A and 3B), and a fully extended (and locked) position (as shown in FIGS. 4A and 4B). With further reference to FIGS. 3A and 3B, a locking mechanism can be provided that in one embodiment includes a release handle 24 at the rearward-most edge of sliding floor extension plate 20 between stored and extended positions. The extension plate 20 can optionally further include components that will allow the truck bed or cargo area to be divided into compartments or to mount, attach or otherwise include containers or other items in the truck bed or cargo area such as a plurality of molded or drilled peg-receiving holes or apertures 26 for mounting cargo dividers or other restraining devices, specialized containers, toolboxes, and the like. Also shown in FIGS. 3A and 3B are indicators for use as a template in determining mounting locations for the assembly rails 18 and tracks 22, such as where the rails 18 are mounted, connected or otherwise attached to the floor of the bed/cargo area (rather than being molded/formed/stamped or otherwise made integral with the structure of the bed/cargo area), such as pilot holes 27 that are arranged in a continuous preset pattern along extension plate 20 and rails 18.

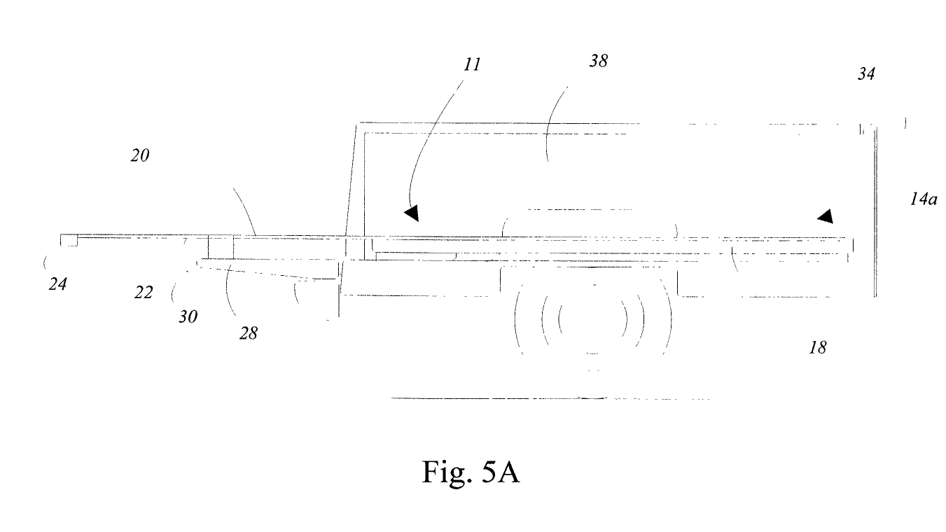

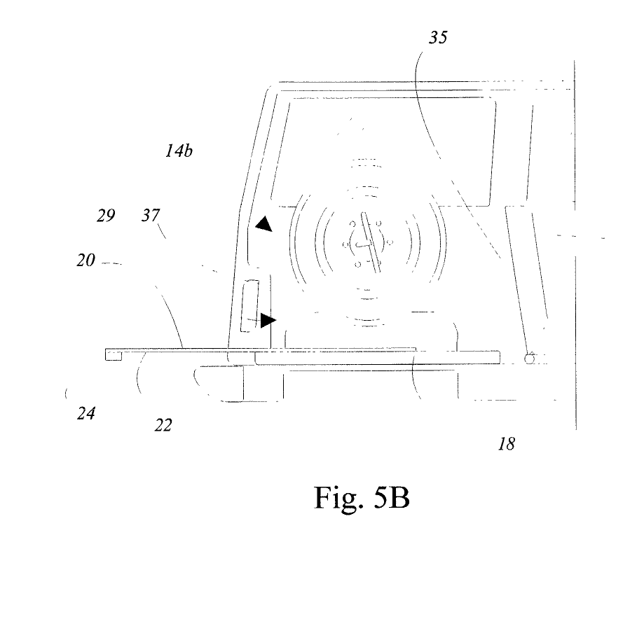

As shown in FIGS. 4A and 5A for a pickup truck having a bed 14a with a forward or cab end 34 and side walls 38, sliding floor extension plate 20 associated with track and rail assemblies 16 of FIGS. 1A and 2A/2B (mounted on truck bed 14a) can extend past lowered tailgate 28, and can be supported by or rest on supports or pads 30 made from metal and/or composite materials that are fastened or otherwise attached to, or preferably molded/stamped/formed or otherwise made integral with, the inner surface of tailgate 28 that forms a portion of the truck bed 14a. FIGS. 4B and 5B provide similar views for an SUV vehicle having a cargo bed 14b with a forward end 35 and side walls 37 where the sliding floor extension plate 20 associated with track and rail assemblies 16 of FIGS. 1B and 2A/2B (mounted on the floor of cargo area 14b) can extend past the opening 29 of the cargo area 14b.

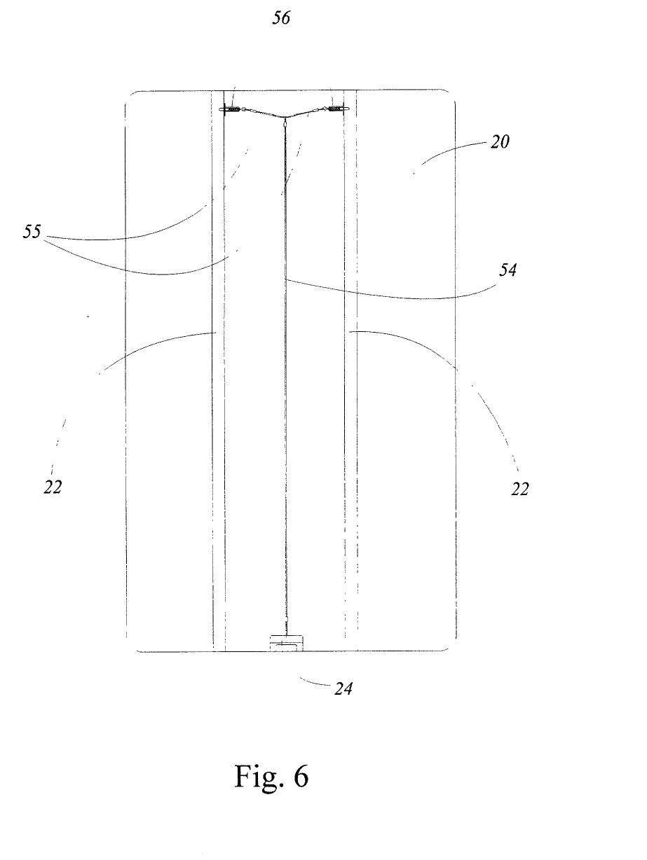

FIG. 6 provides a view of the underside of the sliding floor extension plate 20 of FIG. 1A that shows the locking mechanism of the present invention for securing extension plate 20 in various locked and secured positions. This locking mechanism includes a release handle or grip member 24, a flexible cable or connector 54 attached at one end to handle 24 and having a branched section 55 at the other end, and to two spring-loaded pins or other form of mechanism 56 at the forward or cab end of the truck bed for releasably securing track 22 in a locked or secured position with respect to rail 18. As shown in FIG. 6, each of the 56 pins are connected to one branch of the branched section 55 at the other end of cable 54.

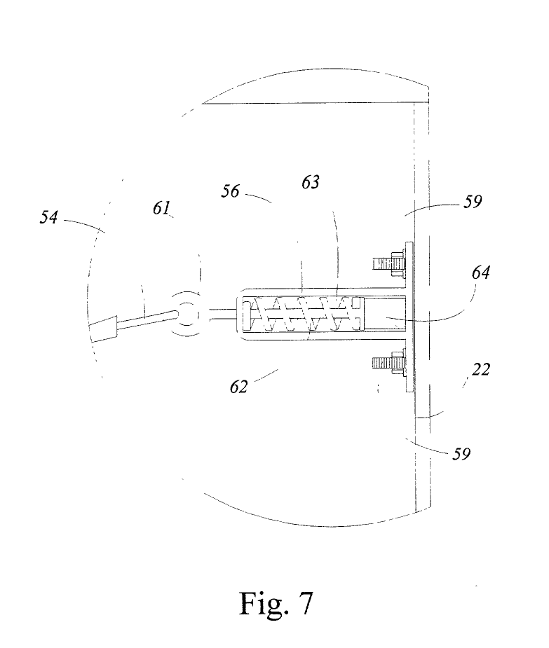

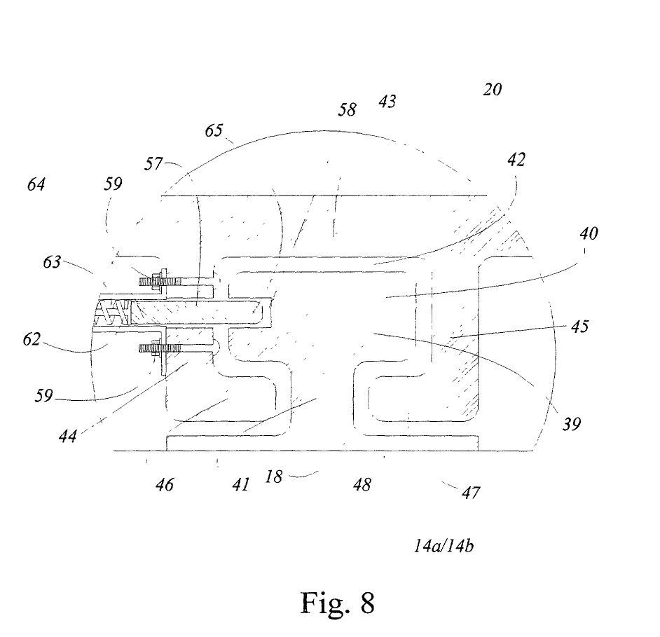

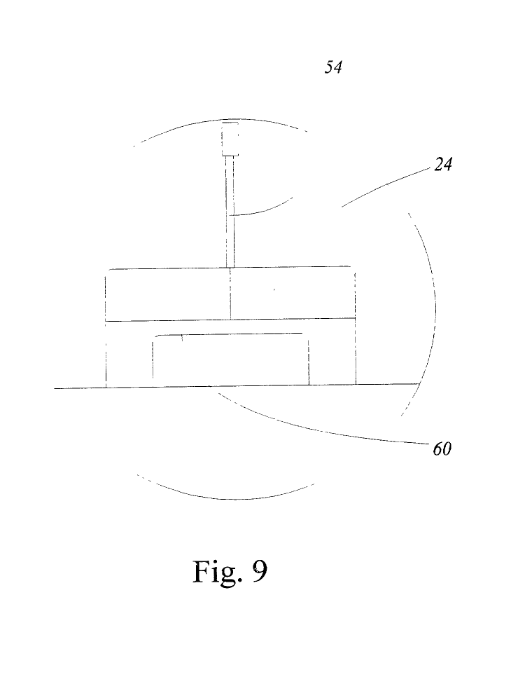

As shown in FIGS. 6 and particularly 7, each pin 56 is attached to the L-arm 44 of one of the respective tracks 22 at the forward or cab end 34 by screws/nuts or other suitable fasteners 59 and is comprised of an eye bolt for attachment of cable 54, a spring 62, and a pin portion 64 that slides within chamber 63 and is biased by spring 62. As shown in FIG. 7 and particularly in FIG. 8, pin portion 64 is normally biased by spring 62 to protrude into hole 57 in arm 44 of track 52 so that the end 65 of the pin portion 64 can enter a molded or drilled hole 58 in the head portion 40 of rail 18 to lock or secure track 22 in position and thus lock or secure sliding floor extension plate 20 in place. Indeed, there are typically a plurality of holes 58 spaced along rail 18 at predetermined intervals to allow track 22 to be locked or secured in a variety of positions, including from fully extended to fully stored positions.

In order to release track 22 from a secured and locked position relative to rail 18, handle 24 includes a release trigger portion 60. When operated to unlock track 22, release trigger 60 (through cable 54) causes pin portion 64 to move within hole 57 away from rail 18, thus causing end 65 of pin portion 64 to also move away or retract from hole 58 so that track 22 can freely slide along track 18 to a different position. When operated to lock and secure track 22 in the desired position, release trigger 60 (through cable 54) allows spring 62 to bias pin portion 64 within hole 57 in track 22 towards rail 18 and thus cause end 65 to protrude into and engage one of the holes 58 in rail 18.

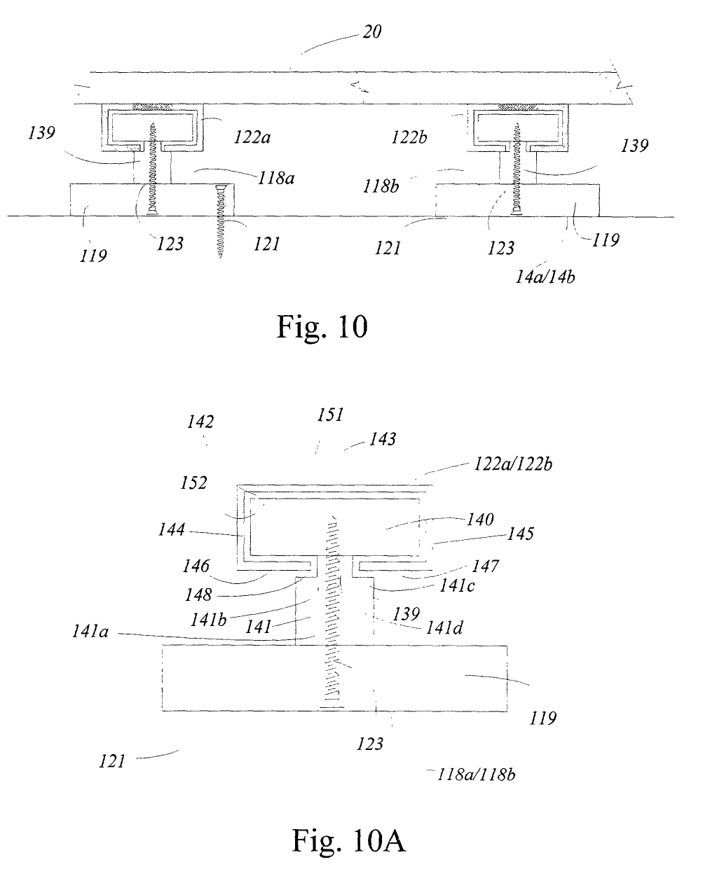

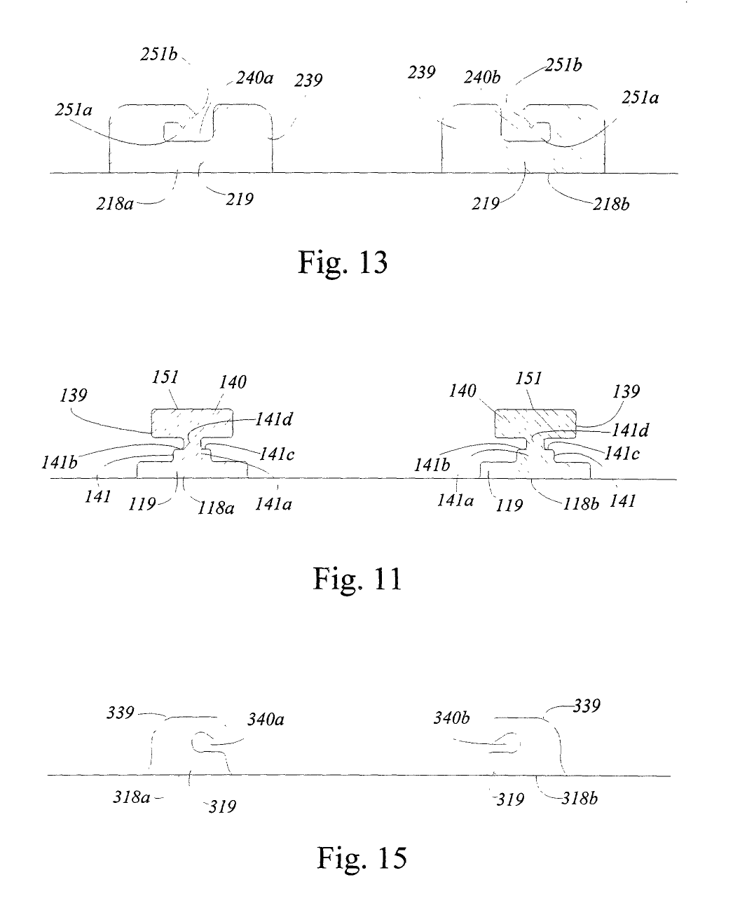

An alternative embodiment of the slidable assembly of FIGS. 1A, 1B and 2A is shown in FIGS. 10 and 10A, and involves a pair of rails 118a and 118b (preferably made of a relatively low coefficient of friction polymer such as ultra high molecular weight polyethylene), each in combination with a generally C-shaped (or U-shaped) track 122a or 122b (preferably made of a metal such as aluminum). As shown in FIG. 10 and particularly FIG. 10A, each rail 118a and 118b includes of a base segment 119 that is attached to the bed/cargo area 14a/14b by a screw 121 or other suitable fastener and a generally T-shaped guide segment 139 comprised of a head portion 140 and a neck 141 portion adjacent to base segment 119 that are held together by a screw 123 or other suitable fastener. Neck portion 141 comprises a wider lower section 141a having a pair of spaced apart shoulders 141b and 141c, and a narrower upper section 141d adjacent to head portion 140. Each of tracks 122a and 122b, which are attached to the underside of plate 20 by base segment 143, has a channel 142 that slidably receives head portion 140 and the upper section 141d of neck portion 141 and a pair of spaced apart generally L-shaped arms 144 and 145 that extend generally outwardly from base segment 143. L-shaped arms 144 and 145 have respective inwardly extending ends 146 and 147 that slide or ride, respectively on shoulders 141b and 141c of neck portion 141 and thus decrease the load bearing surface 152 of tracks 122a/122b on the surface 151 of rails 118a/118b. Ends 146 and 147 also define an opening indicated by 148 that encloses upper section 141d of neck portion 141. Channel 142 of each of tracks 122a/122b is again oriented to face downwardly towards the floor of the bed/cargo area to minimize the collection of dirt and other debris. Instead of separate base segments 119, and head and neck portions 140 and 141 of guide segment 139, tracks 118a/118b can be formed as integral units, as shown in FIG. 11.

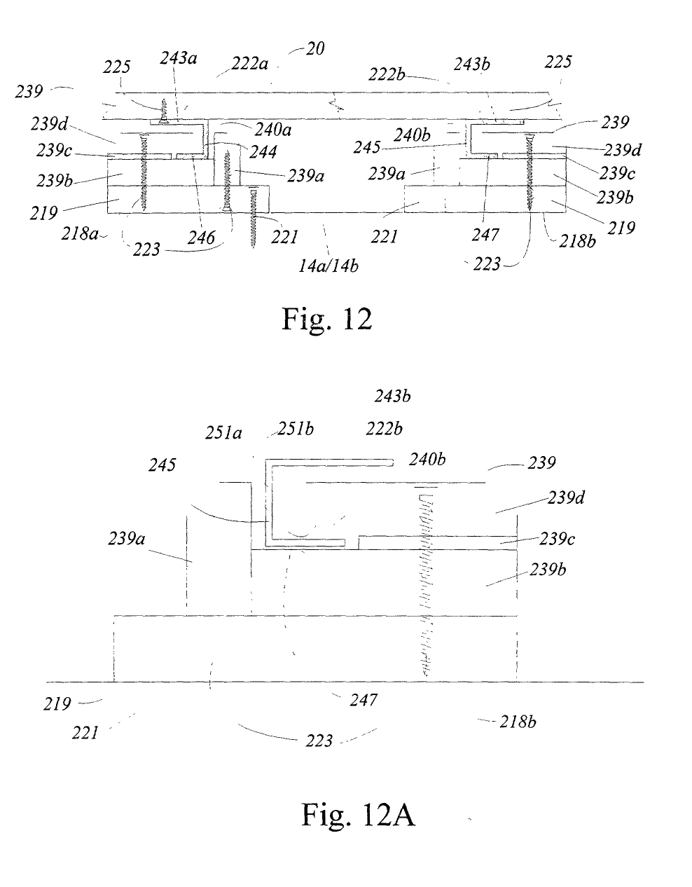

Another alternative embodiment of the slidable assembly of FIGS. 1A, 1B and 2A is shown in FIGS. 12 and 12A, and involves a pair of spaced apart rails 218a and 218b, each in combination with a generally J-shaped track 222a or 222b (each preferably made of a metal such as aluminum). As shown in FIG. 12 and particularly FIG. 12A, each rail 218a and 218b includes a base segment 219 attached to bed/cargo area 14a/14b by screws 221 or other suitable fasteners, and a guide segment 239 that is comprised of guide sections 239a, 239b, 239c and 239d that are held together by screws or other suitable fasteners 223b. (Segment 219, and especially sections 239a, 239b, 239c and 239d, are preferably made of a relatively low coefficient of friction polymer such as ultra high molecular weight polyethylene). The inner wall surfaces of sections 239a, 239b, 239c and 239d together define, respectively, a generally L-shaped slot 240a for rail 218a and a generally L-shaped slot 240b for rail 218b. The surface of each slot 240a and 240b also has a ridge 251a protruding downwardly towards section 239b and a ridge 251b protruding inwardly towards section 239a. As shown in FIG. 12, slots 240a and 240b open upwardly. Each track 222a and 222b, which are attached to the underside of plate 20 by screws 225 or other suitable fastener by base segments 243a or 243b, has an L-shaped arms 244 or 245 with respective ends 246 and 247 that extend outwardly and fit within, respectively, inner slots 240a and 240b, and slide primarily along the lower surface of these slots. Ridges 251a and 251b provide additional reduction in friction and drag in the event ends 246 and 247 move upwardly or laterally within slots 240a and 240b. Instead of separate base section 219 and guide sections 239a, 239b, 239c and 239d, rails 218a and 218b can be formed as an integral units, as shown in FIG. 13.

Another alternative embodiment of the slidable assembly of FIG. 12 is shown in FIG. 14 and involves a rail 318 in combination with a generally J-shaped track 322. As shown in FIG. 14, rail 318 comprises a based segment (shown as being attached to bed/cargo area 14a/14b), guide segments 339a and 339b (shown as being attached to base segment 319) and guide segment 339c (shown as being attached to segment 339b) that are preferably made of a relatively low coefficient of friction polymer such as ultra high molecular weight polyethylene. Segments 339a, 339b and 339c have respective inner wall surfaces that together define inwardly opening slot 340. Track 322 (shown as being attached to the underside of plate 20 by base segment 343) that is preferably made of a metal such as aluminum has an L-shaped arm 344 that extends generally outwardly from base segment 343 and has an end 346 that extends into and rides within slot 340 and slides along surface 351a. Instead of separate segments 339a, 339b and 339c, rail 318 can be formed as integral units 318a and 318b, as shown in FIG. 15, having respective inwardly opening slots 340a and 340b for receiving end 346 of track 322.

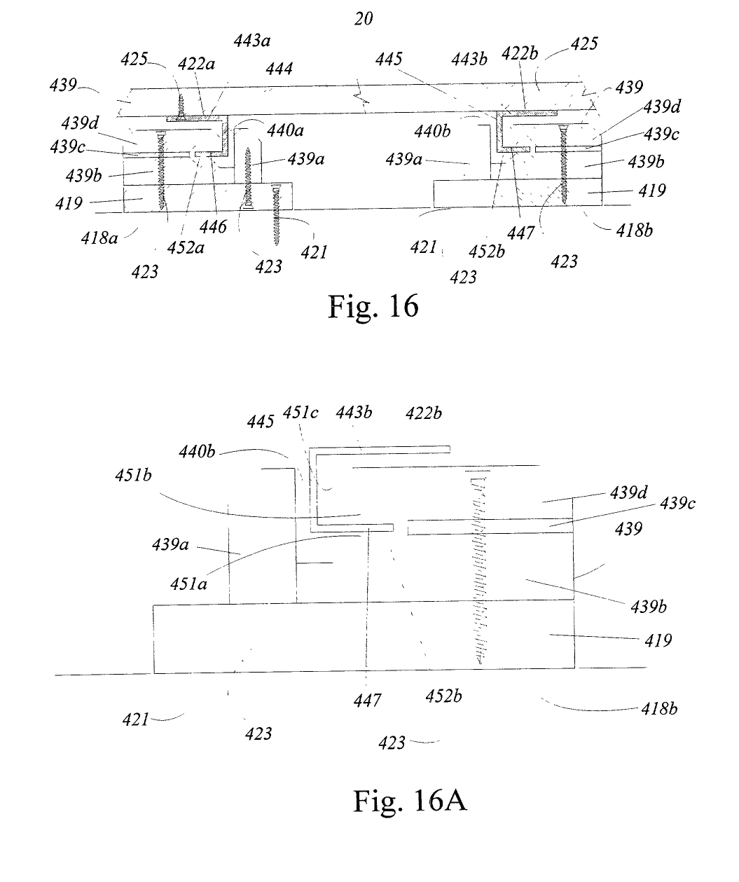

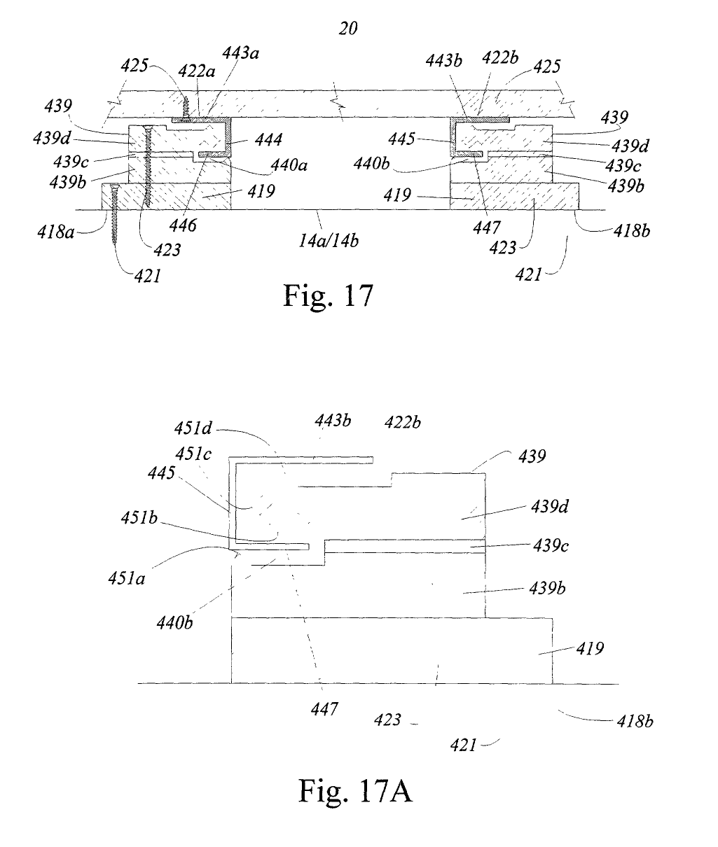

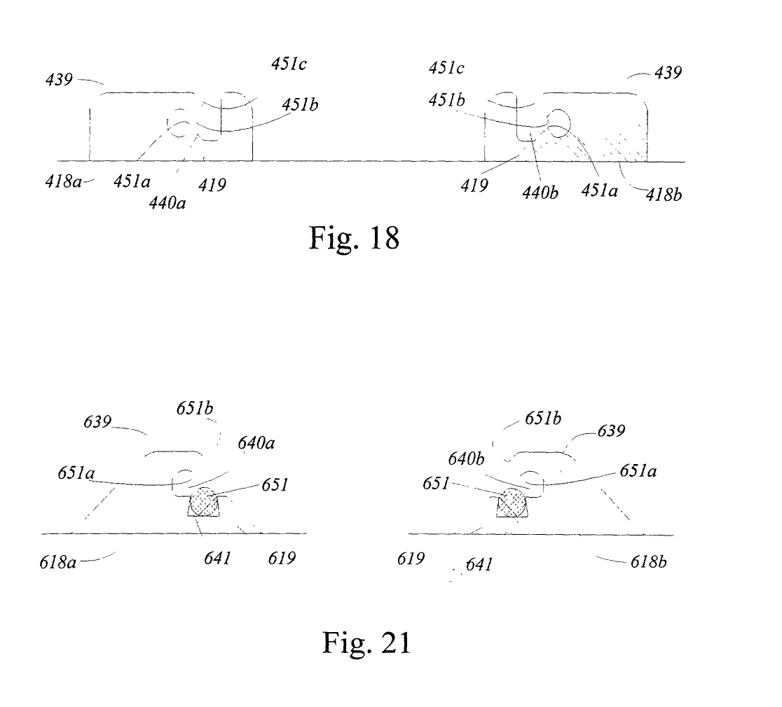

Another alternative embodiment of the slidable assembly of FIG. 12 is shown in FIGS. 16 and 16A, and involves a pair of spaced apart rails 418a and 418b, each in combination with a generally J-shaped track 422a or 422b. As shown in FIG. 16 and particularly in FIG. 16A, each rail 418a and 418b includes a base segment 419 attached to bed/cargo area 14a/14b by screws 421 or other suitable fasteners, and a guide segment 439 that is comprised of guide sections 439a, 439b, 439c and 439d that are held together by screws or other suitable fasteners 423a and 423b. (Segment 419, and especially sections 439a, 439b, 439c and 439d, are preferably made of a relatively low coefficient of friction polymer such as ultra high molecular weight polyethylene). Sections 439a, 439b, 439c and 439d have respective inner wall surfaces that together define, respectively, generally L-shaped slot 440a for rail 418a and generally L-shaped slot 440b for rail 418b. As shown in FIG. 16, slots 440a and 440b open upwardly. The surface of each slot 440a and 440b also has a ridge 451a protruding upwardly therefrom, a ridge 451b protruding downwardly towards ridge 451a, and a ridge 451c protruding inwardly toward section 439a. Each track 422a and 422b (which are attached to the underside of plate 20 by screws 425 or other suitable fastener by base segments 443a or 443b and are preferably made of a metal such as aluminum) has L-shaped arms 444 or 445 that extend generally outwardly from base segment 443a or 443b. Each arm 444 and 445 has respective ends 446 and 447 that extend outwardly into and ride within, respectively, inwardly opening slots 440a and 440b and have surfaces 452a and 452b that slide along ridge 451a to minimize the load bearing surface of rails 418a/418b that tracks 422a/422b slide or ride on. Ridges 451b and 451c provide additional reductions in friction and drag in the event ends 446 and 447 move upwardly or laterally within slots 440a and 440b. As shown in the alternative embodiment of FIG. 16 shown in FIGS. 17 and 17A, rails 418a and 418b can be formed without segment 439a, (for ease of fabrication) and include another upwardly extending ridge 451d to minimize the load bearing surface of rails 418a/418b. As shown in FIG. 18, instead of separate base segment 419 and guide segments/sections 439a, 439b, 439c and 439d, rails 418a and 418b of FIG. 16 can be formed as an integral units.

Another alternative embodiment of the slidable assembly of FIGS. 10 and 12 is shown in FIG. 19 and involves a generally J-shaped rail 518 in combination with a generally C-shaped (or U-shaped) track 522. As shown in FIG. 19, rail 518 attached to bed/cargo area 14a/14b and comprises guide segments 539a, 539b, 539c and 539d that are preferably made of a relatively low coefficient of friction polymer such as ultra high molecular weight polyethylene and are held together by screw 523 or some other suitable fastener. Segments 539a, 539b, 539c and 539d have respective inner wall surfaces that together define slot 540. Track 522 is preferably made of a metal such as aluminum and has a channel 542 that slidably receives tip 539e of upper segment 539d protruding through opening 548, a base segment 543 and a pair of spaced apart upper and lower L-shaped arms 544 and 545 that extend generally outwardly from base segment 543 to define channel 542. Arms 544 and 545 have inwardly extending ends 546 and 547 that define an opening indicated by 548 and enclose tip portion 539e of segment 539d. Also shown in FIG. 19 is a strip 552 of a material such as stainless steel that is adhered or otherwise attached to lower arm 545 that has greater strength and abrasion resistance than the material that track 522 is typically made out of, such as aluminum. As shown in FIG. 19, end/arm 547/545 of track 522 slides along and rides within slot 540 with strip 552 being in contact with the surface of segment 539b of rail 518.

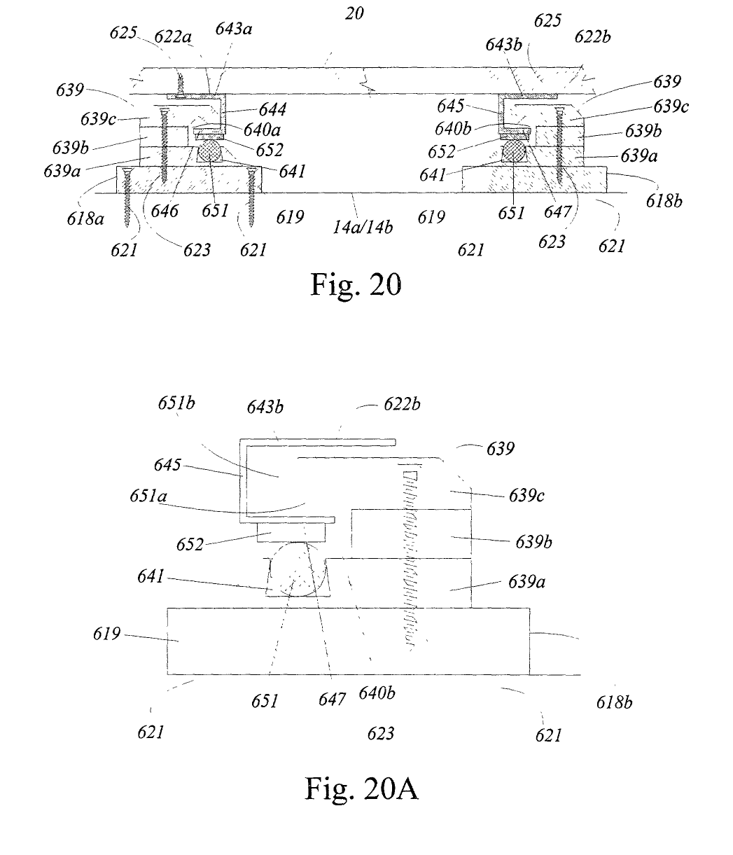

Another alternative embodiment of the slidable assembly of FIGS. 12 and 19 is shown in FIGS. 20 and 20A, and involves a pair of spaced apart rails 618a and 618b, each in combination with a generally J-shaped track 622a or 622b. As shown in FIG. 20 and particularly in FIG. 20A, each rail 618a and 618b includes a base segment 619 attached to bed/cargo area 14a/14b by screws 621 or other suitable fasteners and a guide segment 639 that is comprised of guide sections 639a, 639b and 639c that are held together by screws or other suitable fasteners 623. Sections 639a, 639b and 639c have inner wall surfaces that together define, respectively, inwardly opening slot 640a for rail 618a and inwardly opening slot 640b for rail 618b. Each slot 640a and 640b also has a recess or groove 641 that receives and holds in place by a snap-fit or other suitable means a cylindrical rod or strip 651 that is preferably made of a relatively low coefficient of friction polymer such as ultra high molecular weight polyethylene if tracks 622a and 622b are made from a metal such as aluminum. Each slot 640a and 640b also has a ridge 651a protruding downwardly toward trip 651 and a ridge 651b protruding inwardly. Each track 622a and 622b, which are attached by base segment 643a or 643b to the underside of plate by screws 625 or other suitable fastener, has an L-shaped arm 644 or 645 that extends generally outwardly from base segment 643a or 643b. Arms 644 and 645 each have ends 646 and 647 that extend outwardly into and slide or ride within, respectively, inwardly opening slots 640a and 640b. As also shown in FIG. 20, ends 646 and 647 of arms 644 and 645 each have a strip 652 made of a material such as stainless steel that is adhered or otherwise attached thereto and is contact with the surface of strip 651. Ridges 651a and 651b provide additional reductions in friction and drag in the event ends 646 and 647 move upwardly or laterally within slots 640a and 640b. Instead of separate segments 619, 639a, 639b and 639c, rails 618a and 618b can be formed as integral units, as shown in FIG. 21.

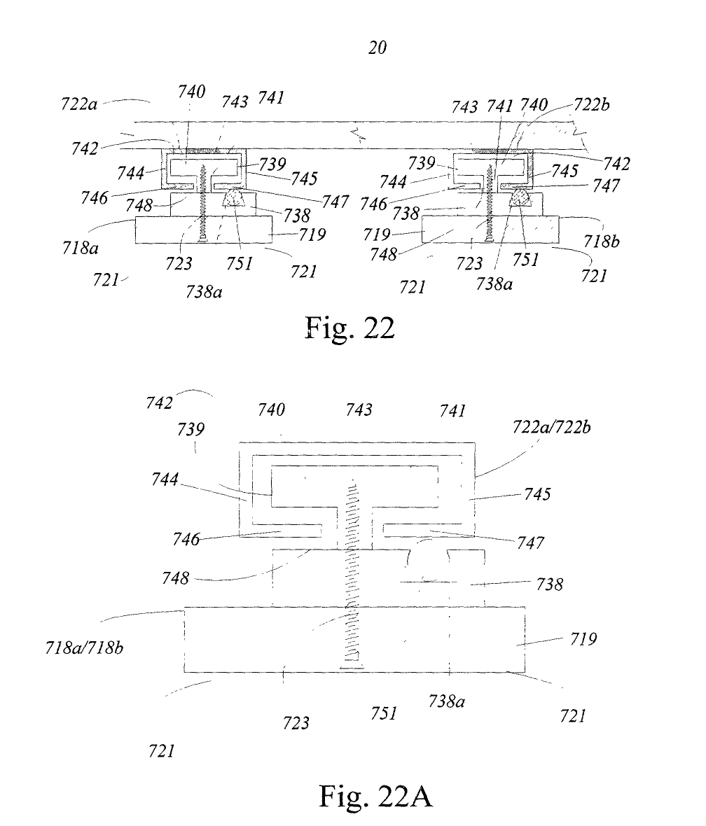

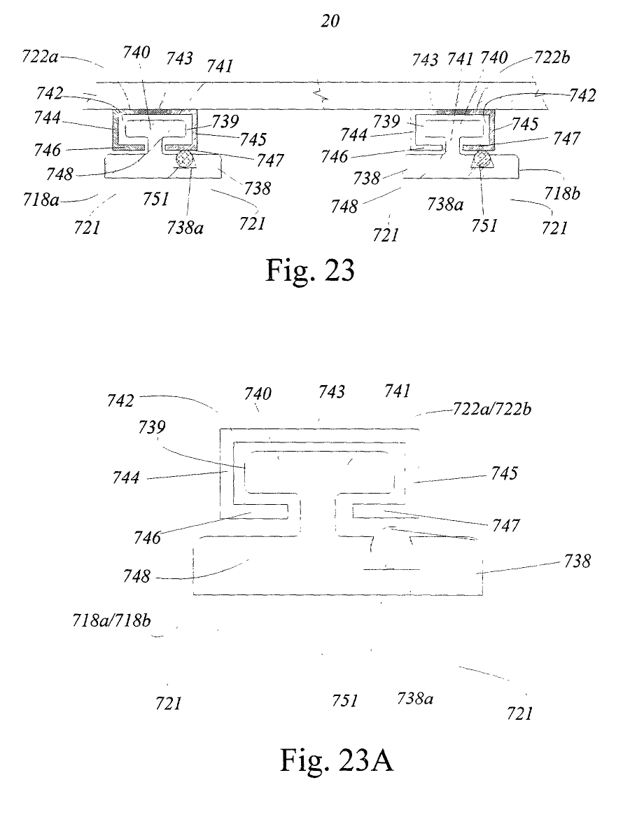

An alternative embodiment of the slidable assembly of FIG. 10 is shown in FIGS. 22 and 22A, and involves a pair of rails 718a and 718b, each in combination with a generally C-shaped (or U-shaped) track 722a or 722b that are preferably made of a metal such as aluminum. As shown in FIG. 22 and particularly in FIG. 22A, each rail 718a/718b includes a base segment 719 that is attached to the bed/cargo area 14a/14b by a screws 721 or other suitable fastener, an intermediate segment 738 on top of base segment 719 and a generally T-shaped segment 739 comprised of head portion 740 and a neck portion 741 adjacent to intermediate segment 738 that are held together by a screw 723 or other suitable fastener. As shown in FIG. 22, intermediate segment 738 has a recess or groove 738a that receives and holds in place by a snap-fit or other suitable means a cylindrical rod or strip 751 that is preferably made of relatively low coefficient of friction polymer such as ultra high molecular weight polyethylene if tracks 722a/722b are made from a metal such as aluminum. Each of tracks 722a/722b, which include a base segment 743 attached to the underside of plate 20, has a channel 742 that slidably receives head portion 740 and a pair of spaced apart generally L-shaped arms 744 and 745 that extend generally outwardly from the base segment 743. Arms 744 and 745 have respective ends 746 and 747 that extend inwardly to define an opening indicated by 748 and enclose neck portion 741. As shown in FIG. 22, the outer surface of arm/end 745/747 slides or rides on the surface of strip 751. Channel 742 of each of tracks 722a/722b is again oriented to face downwardly towards the floor of the bed/cargo area to minimize the collection of dirt and other debris. Instead of separate base, intermediate and T-shaped segments 719, 738 and 739, tracks 718a/718b can be formed as integral units (also without base segment 719 and with segment 738 being attached to bed/cargo area 14a/14b), as shown in FIGS. 23 and 23A.

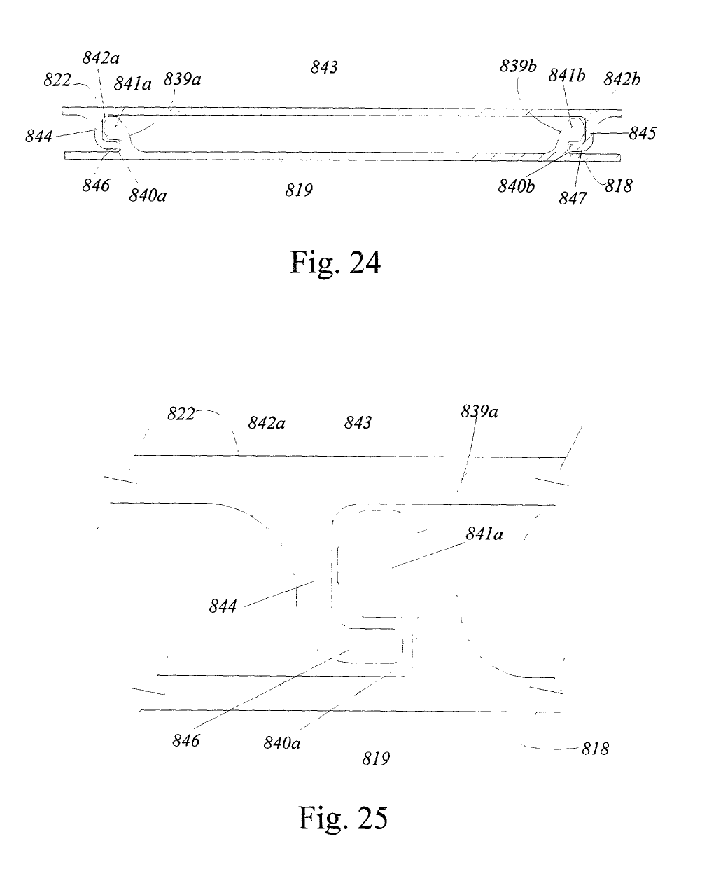

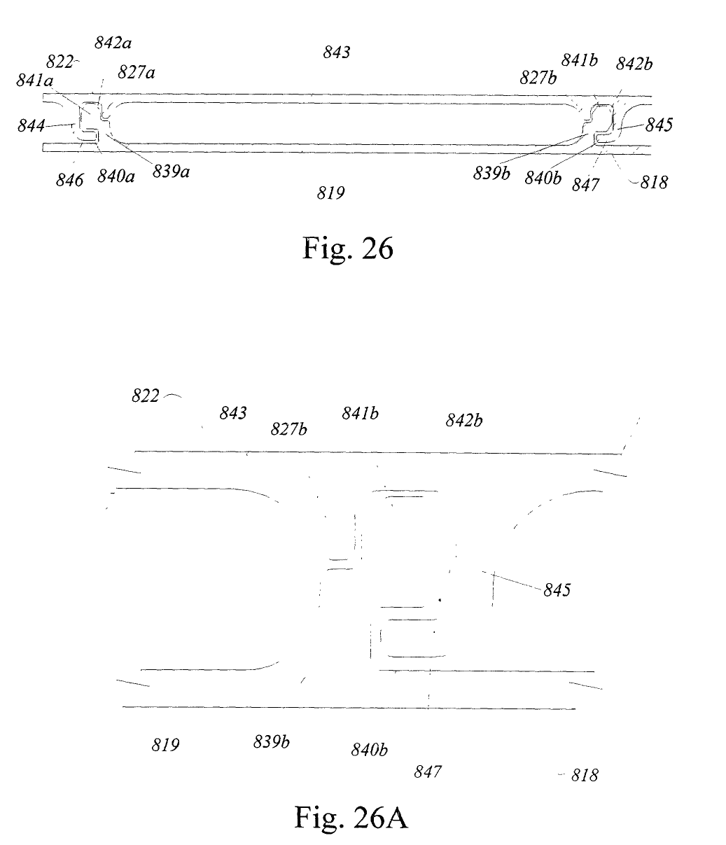

Another alternative embodiment of the slidable assembly of the present invention is shown in FIGS. 24 and 25, and involves a guide member 818 integral with bed/cargo area 14a/14b and a follower member 822 integral with plate 20 that are configured to provide an interlocking yet slidable fit. As shown in FIG. 24 and particularly in FIG. 25, guide member 818 has a base segment 819 and a pair of spaced apart generally L-shaped rail segments 839a and 839b that extend outwardly from base segment 819 and define respective outwardly opening slots 840a and 840b. Follower member 822 has a base segment 843 and a pair of spaced apart generally L-shaped track segments 844 and 845 that extend outwardly from base segment 843 and define respective inwardly opening slots 842a and 842b. Rail segments 839a and 839b also have respective ends 841a and 841b that extend outwardly into, and slide or ride within respective inwardly opening slots 842a and 842b, while track segment 844 and 845 also have respective ends 846 and 847 that extend inwardly into, and slide or ride within respective outwardly opening slots 840a and 840b. In an alternative embodiment shown in FIGS. 26 and 26A, follower member 822 can further include a pair spaced apart inner guide segments 827a and 827b to further define slots 842a and 842b and to enclose ends 841a and 841b segments 839a and 839b to minimize lateral movement of follower member 822. The configuration and orientation of guide member 818 and follower member 822 can also be reversed so that slots 840a and 840b open inwardly to receive outwardly extending ends 846 and 847, while slots 842a and 842b face outwardly to receive inwardly extending ends 841a and 841b.

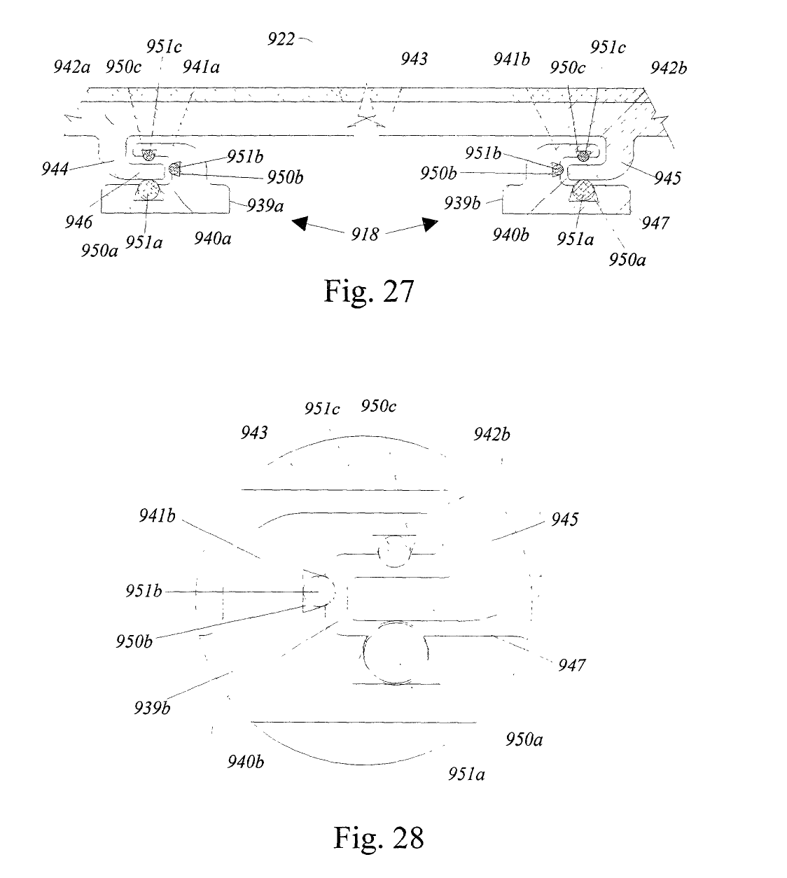

Another alternative embodiment of the slidable assembly of FIGS. 24 and 26 is shown in FIGS. 27 and 28, and involves a guide member 918 in the form of a pair of spaced apart generally L-shaped rail segments 939a and 939b that have respective outwardly opening slots 940a and 940b. As shown in FIG. 27 and particularly in FIG. 28, each of slots 940a and 940b has a recess or groove 950a, 950b and 950c in, respectively, the bottom wall, side wall and top wall thereof that receives and holds in place by a snap fit or other suitable means, respectively, a cylindrical rod or strip 951a, 951b or 951c that are preferably made of a relatively low coefficient of friction polymer such as ultra high molecular weight polyethylene, especially if follower member 922 is made from a metal such as aluminum. Follower member 922 has a base segment 943 and a pair of spaced apart generally L-shaped track segments 944 and 945 that extend outwardly from base segment 943 and define respective inwardly opening slots 942a and 942b. Rail segments 939a and 939b also have respective ends 941a and 941b that extend outwardly into, and slide or ride within respective inwardly opening slots 942a and 942b, while track segment 944 and 945 also have respective ends 946 and 947 that extend inwardly into respective outwardly opening slots 940a and 940b and generally ride or slide on strip 951a as the main load bearing surface. Strips 951b and 951c provide additional reductions in friction and drag in the event ends 946 and 947 move upwardly or laterally within slots 940a and 940b. Like the embodiment of FIGS. 24, 25 and 26, the configuration and orientation of rail segments 939a/939b and follower member 922 can be reversed.

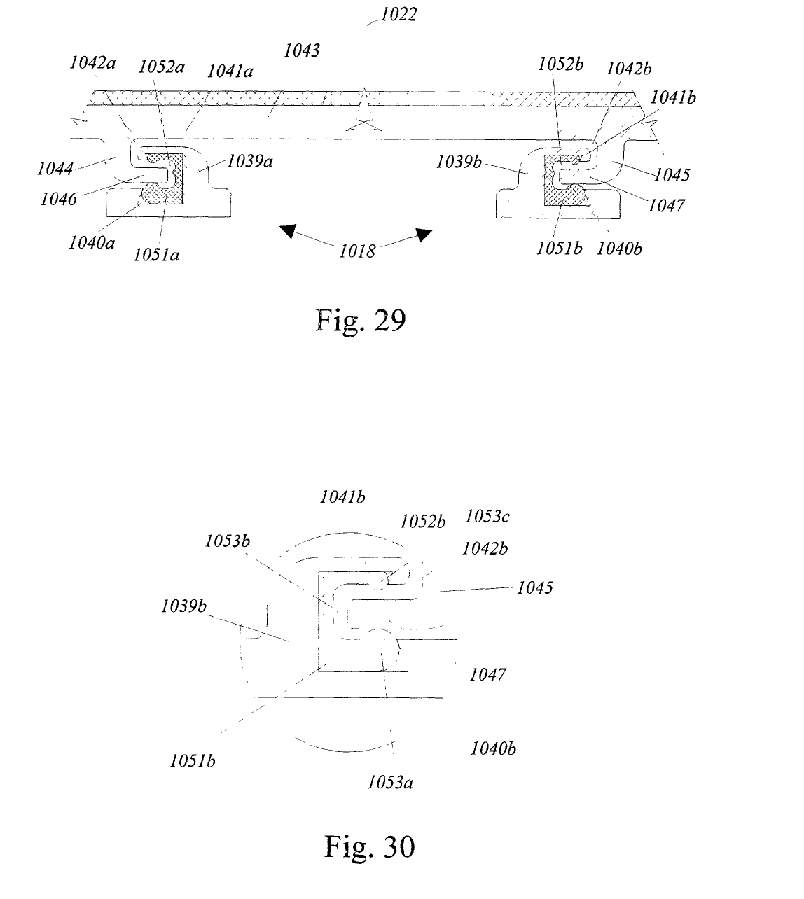

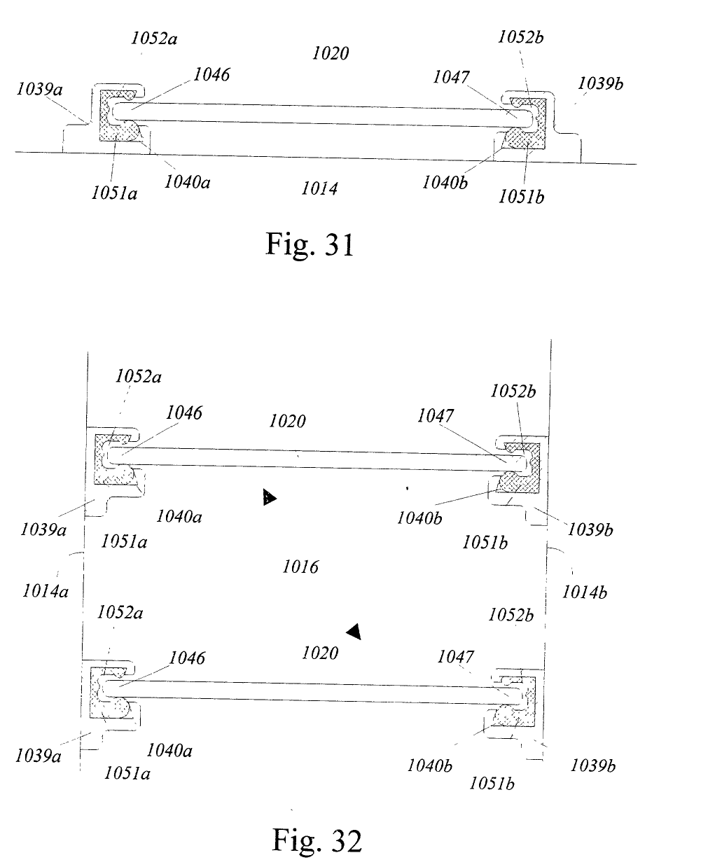

Another alternative embodiment of the slidable assembly of FIGS. 27 and 28 is shown in FIGS. 29 and 30, and involves a guide member 1018 in the form of a pair of spaced apart generally L-shaped rail segments 1039a and 1039b that define respective outwardly opening generally C-shaped (or U-shaped) recesses or grooves 1040a and 1040b. As shown in FIG. 29 and particularly in FIG. 30, recesses 1040a and 1040b each receive and hold in place by a snap fit or other suitable means, respectively, generally C-shaped (or U-shaped) inserts 1051a or 1051b that are preferably made of ultra high molecular weight polyethylene, especially if follower member 1022 is made from a metal such as aluminum. Inserts 1051a and 1051b each have, respectively, an outwardly opening slot 1052a or 1052b. As shown particularly in FIG. 30, each of the slots 1052a and 1052b have ridges 1053a, 1053b and 1053c that protrude, respectively, from the bottom wall, side wall and top wall surfaces of the slot. Follower member 1022 has a base segment 1043 and a pair of spaced apart generally L-shaped track segments 1044 and 1045 that extend outwardly from base segment 1043 and define respective inwardly opening slots 1042a and 1042b. Rail segments 1039a and 1039b also have respective ends 1041a and 1041b that extend outwardly into respective inwardly opening slots 1042a and 1042b, while track segments 1044 and 1045 also have respective ends 1046 and 1047 that extend inwardly into respective outwardly opening slots 1052a and 1052b and generally ride or slide within these slots. Ridge 1053a provides the main load bearing surface, while ridges 1053b and 1053c provide additional reductions in friction and drag in the event ends 1046 and 1047 move upwardly or laterally within slots 1052a and 1052b. Like the embodiment of FIGS. 27 and 28, the configuration and orientation of rail segments 1039a/1039b and follower member 1022 can be reversed. In an alternative embodiment shown in FIG. 31, rail segments 1039a and 1039b can be attached to base 1014 and oriented such that slots 1052a and 1052b of respective inserts 1051a and 1050b open inwardly so that slots 1052a and 1052b are opposing. As also shown in FIG. 31, slots 1052a and 1052b can slidably receive the respective ends or edges 1046 and 1047 of a movable or slidable platform member that replaces follower member 1022, such as movable or slidable shelf 1020. In another alternative embodiment shown in FIG. 32, rail segments 1039a and 1039b can be oriented and attached respectively to a pair of vertically spaced walls 1014a and 1014b such that slots 1052a and 1052b of respective inserts 1051a and 1051b again open inwardly and are opposing to slidably receive respective ends or edges 1046 and 1047 of movable or slidable shelf 1020. As also shown in FIG. 32, a plurality of such combinations 1011 of rail segments 1039a/1039b and movable/slidable shelf 1020 can also be used.

As shown by the foregoing detailed description, the present invention provides for a slidably assembly for movable platforms or other movable structural members that can be used with a variety of mobile and stationary structures and in particular with the cargo area of motor vehicles to provide an integrated sliding floor extension that can be locked and stored in a forward, non-extended stored position or pulled rearwardly and locked at spaced intervals up to a fully extended position past the lowered tailgate of the truck or the opening of the cargo area of other vehicles such as an SUV to allow for ease of access to load or unload items and/or to accommodate oversized load items. It should also be noted that the specific embodiments of the present invention that are described therein are to be considered illustrative and exemplary of the present invention, are subject to variations in structure, design, application and methodology and are therefore not to be limiting in scope of the present invention. Accordingly, it will be apparent to those skilled in the art that various modifications thereto can be made without departing from the spirit and scope of the present invention as defined in the appended claims.

What is claimed is:

1. An interlocking slidable assembly for use with a movable structural member and a base member, which comprises:
a. an elongated guide member associated with one of the structural member and the base member;
b. a follower member associated with the other of the structural member and the base member that is configured to slidably interlock with the guide member and has a surface slidably in contact with a surface of the guide member so as to be movable along the guide member from a first position to a second position;
c. wherein the surfaces of the follower member and guide member comprise materials, that provide, in combination, a relatively low coefficient of friction therebetween.

2. The assembly of claim 1 wherein the coefficient of friction between the surfaces of the follower member and guide member is about 0.1 or less.

3. The assembly of claim 2 wherein one of the surfaces of the follower member and guide member comprises a material selected from the group consisting of metals, plastics and relatively low coefficient of friction polymers, and wherein the other of the surfaces comprises a relatively low coefficient of friction polymer.

4. The assembly of claim 3 wherein metal is selected from the group consisting of aluminum and stainless steel, and wherein the relatively low coefficient of friction polymer is selected from the group consisting of ultra high molecular weight polyethylene and polytetrafluoroethylene.

5. The assembly of claim 2 wherein the guide member comprises a pair of spaced apart elongated rails and wherein the follower member comprises a pair of elongated tracks, each track receiving and being configured to slidably interlock with one of the rails.

6. The assembly of claim 5 wherein each rail comprises a generally T-shaped guide segment having a head portion and a neck portion, and wherein each track is generally C-shaped and has a base segment, a pair of spaced apart generally L-shaped arms extending outwardly from the base segment and defining a channel that slidably receives the head portion of the guide segment, each arm having an inwardly extending end.

7. The assembly of claim 6 wherein the neck portion of the guide segment comprises a wider lower section having a pair of spaced apart shoulders and a narrower upper section adjacent the head portion, and wherein each end of each arm is slidable on one of the shoulders of the lower section of the neck portion and wherein the ends enclose the narrow upper section.

8. The assembly of claim 6 wherein each rail comprises a second segment adjacent the guide segment, the second segment having a recess that receives a strip made of a relatively low coefficient of friction polymer and wherein one of the ends of one of the arms of each track is made of a metal and is slidable along the surface of the strip of one of the rails.

9. The assembly of claim 5 wherein each rail comprises a guide segment having a slot and wherein each track has an L-shaped arm, each arm having an outwardly extending end that fits within and is slidable along the surface of one of the slots.

10. The assembly of claim 9 wherein each slot has a surface made of a relatively low coefficient of friction polymer and wherein the end of each arm is made of a metal.

11. The assembly of claim 10 wherein the surface of each slot has a ridge protruding therefrom and wherein the end of each arm is slidable along the ridge of one of the slots.

12. The assembly of claim 14 wherein each slot opens inwardly and has a recess that receives a strip made of a relatively low coefficient of friction polymer and wherein the end of each arm is made of a metal and is slidable along the surface of the strip of one of the slots.

13. The assembly of claim 12 wherein the end of each arm has attached thereto a strip of stainless steel that is slidable along the surface of the strip of one of the slots.

14. The assembly of claim 13 wherein the end of the lower arm has attached thereto a strip of stainless steel that is slidable along the surface of the slot.

15. The assembly of claim 2 wherein the guide member comprises a pair of spaced apart generally L-shaped rail segments that have outwardly extending ends and outwardly opening slots and wherein the follower member comprises a pair of generally L-shaped track segments that have inwardly extending ends and inwardly opening slots, the end of each rail segment extending outwardly into and sliding within the inwardly opening slot of one of the track segments, the end of each track segment extending inwardly into and slidable within the outwardly opening slot of one of the rail segments.

16. The assembly of claim 15 wherein the slot of each rail segment has a recess that receives a strip made of a low coefficient of friction polymer and wherein the end of each track segment is slidable along the surface of the strip of the slot of one of the rail segments.

17. The assembly of claim 16 wherein each rail segment has a recess that receives an insert made of a relatively low coefficient of friction polymer, the insert having formed therein the outwardly opening slot.

18. The assembly of claim 17 wherein the surface of the outwardly opening slot has an upwardly protruding ridge and wherein the end of each track segment is slidable along the upwardly protruding ridge of the slot of one of the rail segments.

19. The assembly of claim 2 wherein the guide member comprises a pair of spaced apart rail segments, each rail segment having an insert made of a relatively low coefficient of friction polymer, the insert having formed therein a slot, the rail segments being oriented so that the slots of the respective inserts are opposing, and wherein the follower member has a pair of spaced apart ends, each end of the follower member extending into and slidable within one of the slots.

20. The assembly of claim 19 wherein the surface of each slot has an upwardly protruding ridge, and wherein each end of the follower member is slidable along the upwardly protruding ridge of one of the slots.

21. The assembly of claim 20 wherein the follower member is a movable shelf.

22. A slidable extensible platform for use with a motor vehicle cargo area having a cargo bed, which comprises:
a. a platform member;
b. an elongated rail associated with one of the platform member and the cargo bed;
c. an elongated track associated with the other of the platform member and the cargo bed and being configured to slidably interlock with the rail and having a surface slidably in contact with a surface of the rail so that the track is movable from a first to a second position along the rail;
d. wherein the surfaces of one of the track and the rail that are slidably in contact are made from materials that provide, in combination, a coefficient of friction of about 0.1 or less therebetween.

23. The platform of claim 22 wherein one of the surfaces comprises a material selected from the group consisting of metals, plastics and relatively low coefficient of friction polymers and wherein the other of the surfaces is comprises a relatively low coefficient of friction polymer.

24. The platform of claim 23 wherein the rail comprises a generally T-shaped guide segment having a head portion and a neck portion, and wherein the track is generally C-shaped and has a base segment, a pair of spaced apart generally L-shaped arms extending outwardly from the base segment and defining a channel that slidably receives the head portion of the guide segment, each arm having an inwardly extending end.

25. The platform of claim 24 which comprises a pair of spaced apart rails, each rail having associated therewith one track that is configured to slidably interlock with the rail.

26. The platform of claim 25 wherein the tracks are attached to the underside of the platform member, wherein the rails are attached to the cargo bed, and wherein the track is oriented so that the channel faces downwardly towards the cargo bed.

27. The platform of claim 22 which further comprises a locking mechanism for securing the platform member in a locked position.

28. The platform of claim 27 wherein the locking mechanism comprises at least one spring loaded pin attached to the track and a plurality of holes spaced along the rail, the at least one spring loaded pin having a pin portion with end capable of protruding into one of the plurality of holes and a spring capable of biasing the end of the pin portion to protrude into the one of the plurality of holes so that the track is in a locked position.

29. The platform of claim 28 wherein the locking mechanism further comprises a flexible connector attached to the at least one spring loaded pin for causing the end of the pin portion to retract from the one of the plurality of holes so that the track is freely movable along the rail.

30. The platform of claim 22 wherein the platform member further includes a plurality of peg-receiving holes.

31. A movable structure for use with a base member, which comprises:
a. a movable structural member;
b. an elongated guide member associated with the base member;
c. a follower member associated with the movable structural member and having a channel that is configured to slidably receive and interlock with the guide member so as to be movable along the guide member from a first position to a second position;
d. wherein the channel is oriented to face downwardly towards the base member.

32. The structure of claim 31 which is a movable extensible platform and wherein the guide member comprises an elongated rail, wherein the follower member comprises an elongated track configured to slidably interlock with the rail and wherein the structural member is a movable platform member.

33. The platform of claim 32 wherein the rail comprises a generally T-shaped guide segment having a head portion and a neck portion, and wherein the track is generally C-shaped and has a base segment, a pair of spaced apart generally L-shaped arms extending outwardly from the base segment and defining the channel that slidably receives the head portion of the T-shaped segment, each arm having an inwardly extending end.

34. The structure of claim 33 which comprises a pair of spaced apart rails, each rail having associated therewith one track that is configured to slidably interlock with the rail.
